(19) United States
(12) Patent Application Publication
(10) Pub. No.: US 2010/0280700 A1
(43) Pub. Date: Nov. 4, 2010

(54) USER-DISTRIBUTED SHARED VEHICLE SYSTEM

(75) Inventors: Richard A. Morgal, Ramona, CA (US); Daniel D. Sturges, Boulder, CO (US); David Goldschmidt, Bloomfield Hills, MI (US); Robert Ray Hunter, III, Cincinnati, OH (US)

Correspondence Address: HENSLEY KIM & HOLZER, LLC, 1660 LINCOLN STREET, SUITE 3000, DENVER, CO, 80264, US

(73) Assignee: INTRAGO CORPORATION, Boulder, CO (US)

(21) Appl. No.: 12/740,760

(22) PCT Filed: Oct. 31, 2008
(86) PCT No.: PCT/US08/82030

§ 371 Date: Apr. 30, 2010

Related U.S. Application Data
(60) Provisional application No. 61/001,487, filed on Oct. 31, 2007.

(51) Int. Cl. G06Q 10/00; G06Q 90/00; G06F 7/00

(52) U.S. Cl. 701/29; 705/500; 705/5

(57) ABSTRACT

A vehicle resource load in a shared-vehicle system 100 is balanced. A central home-station 104 is provided and allocated a number of vehicles 102. A number of day-stations 106 are associated with the central home-station 104 with facilities for docking and reenergizing the vehicles 102. The vehicles 102 are distributed to one or more of the day stations 106 via operation by distribution-users 108 with journeys originating from the central home-station 104 and terminating at the day-stations 106. The vehicles 102 are provided for limited term use by day-users 110 at the day-stations 106 with a requirement that the vehicles 102 be returned to the day-stations 106 by the end of a respective limited term. The vehicles 102 are returned to the central home-station 104 upon expiration of the limited term use via operation by the distribution-users 108 with journeys originating from the day-stations 106 and terminating at the central home-station 104.

### CROSS REFERENCE

This application claims the benefit of priority pursuant to 35 U.S.C. §119(e) of U.S. provisional application No. 61/001,487 filed 31 Oct. 2007 entitled “User distributed shared vehicle system,” which is hereby incorporated herein by reference in its entirety.

The present application is also related to Patent Cooperation Treaty application no. PCT/US2008/067036 filed 13 Jun. 2008 entitled “Shared vehicle management system,” which is hereby incorporated herein by reference in its entirety.

### BACKGROUND

Vehicle-sharing programs have recently gained popularity to address the unique mobility needs of people needing to move about in different environments. Sharing vehicles allows each vehicle to serve the needs to multiple people versus a privately owned vehicle being underutilized by a single owner. A major challenge associated with sharing vehicles involves how to manage usage of the vehicle to ensure availability of use by a large number of potential users. Vehicle location, maintenance, security, and ease of access are issues that a shared vehicle system must address to assure a high utilization of each vehicle within the operational environment.

Some shared vehicle systems allow the user to obtain a vehicle at a station for a one-way trip and deposit the vehicle at another station when done using the vehicle. Several bicycle rental systems follow this one-way rental model giving the user a high level of destination flexibility provided there are sufficient stations within the operational environment of the system. The disadvantage of the one-way rental model is the inevitable fact that most of the vehicles will be located where people want to go with a shared vehicle, which may not be where people would want to obtain a shared vehicle.

An example of this social-transportation reality can be seen in bicycle rental systems where it is typical to see empty rental stations at the top of a hill and full rental stations at the bottom of the hill. JC Decaux has been operating a one-way bicycle rental system in Lyon, France for over two years. Their annual maintenance cost is over $2,500 per shared bicycle. A majority of the operations cost is expended paying system operators to redistribute vehicles within the system. The cost of vehicle redistribution ultimately will be paid by the end user for the ability to leave a vehicle at any station.

Additionally there is a need to provide a high level of vehicle security at every station where vehicles are left overnight when thieves are more prone to assail unattended vehicles. This adds additional cost in infrastructure and generally tends to reduce the user's sense of access ease to the vehicles.

Alternatively a round-trip rental model can be implemented in a shared vehicle system. In this operational scenario the user is required to bring the vehicle back to the same rental station when done using the vehicle. In certain applications where a round trip is a common mobility pattern, the round-trip model works effectively, for example, near a large concentration of homes or work areas where short errands can be done more quickly using a shared vehicle. The round trip rental model typically works well in stand-alone rental system architectures where there is a single station to serve a large operational area. If a single round-trip station is placed in the center of an operational area, then the user will be forced to return the vehicle to the only station available making it impossible for the user to return the shared vehicle to a different rental station. Train stops are suitable candidates for the round-trip model as the distance between train stops is typically sufficiently long that most users would not attempt to utilize a local mobility vehicle to get from one train station to the next. A shared vehicle rental system at a train stop increases the user's ability to access a larger area around the train stop when compared to foot travel.

Unfortunately utilization of shared vehicles located at a train station may not be as high as desired because most individuals coming off the train are not likely to rent a shared vehicle for a short period of time then return the vehicle at the train station and re-board the train. In addition most people who have a local mobility need do not want to go all the way to the train station just to rent a shared vehicle for a local mobility need. Security at a central location is typically less costly per vehicle when compared to a distributed system where security infrastructure needs to be reproduced at each distributed site. The benefit of having vehicles returned to a central-home-station reduces the operational costs associated with keeping the system balanced and running smoothly, but this system architecture comes with the penalty of reducing the user's trip origin options and destination flexibility which adversely affects system utilization.

The information included in this Background section of the specification, including any references cited herein and any description or discussion thereof, is included for technical reference purposes only and is not to be regarded subject matter by which the scope of the invention is to be bound.

### SUMMARY

Both of the shared vehicle rental systems described above do not take advantage of a basic aspect of mobility: the user's need for a return trip sometime after a period of being at their desired location. In addition, there is a general unwillingness of the user to pay for a shared vehicle when not directly using the shared vehicle to satisfy their own mobility needs. Thus, the shared vehicles are either underutilized (e.g., in a round-trip only rental model) or the shared vehicles tend to accumulate at undesirable rental locations (e.g., in one-way only rental model). To overcome the shortcomings of the two shared vehicle system architectures described above, a user-distributed shared vehicle system architecture is proposed that allows users to leave their vehicle at a specified station with the knowledge that the vehicle will be available for their return trip made later in the day.

In one implementation, a method for balancing a vehicle resource load in a shared-vehicle system is disclosed. The method involves providing a central home-station and allocating a number of vehicles to the central home station as well as providing a number of day-stations associated with the central home-station with facilities for docking and reenergizing the vehicles. The vehicles are distributed to one or more of the day stations via operation by distribution-users with journeys originating from the central home-station and terminating at the day-stations. The vehicles are provided for limited term use by day-users at the day-stations with a requirement that the vehicles be returned to the day-stations by the end of a respective limited term. The vehicles are returned to the central home-station upon expiration of the limited term use via operation by the distribution users with journeys originating from the day-stations and terminating at the central home-station.

In another implementation, a method is provided for allocating vehicle resources in a shared-vehicle system. Initially, a first vehicle docked at a station is assigned to a reserved status to fulfill a first reservation request. Then it is determined whether a second vehicle with lesser energy reserves than the first vehicle also docked at the station can fulfill the first reservation request. If so, the second vehicle is reassigned to the reserved status to fulfill the first reservation request. The first vehicle is released from the reserved status and changed to an available status upon a determination that the second vehicle has sufficient energy reserves to fulfill the first reservation request. Alternatively, the assignment of the first vehicle to the reserved status to fulfill the first reservation request is maintained upon a determination that the second vehicle has insufficient energy reserves to fulfill the first reservation request.

In a further implementation, a user interface for a shared vehicle is provided. The user interface has a first presentation feature presented when the shared vehicle is charging indicating a first relative level of energy storage of an energy storage device for powering the shared vehicle with respect to a fully energized condition and a fully depleted condition. The user interface also has a second presentation feature presented when the shared vehicle is in an operating mode indicating a second relative level of energy storage of the energy storage device with respect to an initial present total energy condition representative of total stored energy available for powering the shared vehicle when the shared vehicle is switched to the operating mode and the fully depleted condition. The second presentation feature initially presents the initial present total energy level as a maximum level of the second relative level when the shared vehicle is switched to the operating mode and then presents a linear proportional representation of present total stored energy available until the vehicle reaches the fully depleted condition corresponding to a minimum level of the second relative level. The user interface further has a third presentation feature indicating a range of travel of the shared vehicle based upon the first relative energy level.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIGS. 1A-1D are schematic views of an implementation of a user-distributed shared vehicle system showing usage of the vehicles at various times throughout a day.

FIG. 2 is a schematic diagram depicting exemplary ranges of typical use for a central station and related day stations in a user-distributed shared vehicle system.

FIG. 3 is an isometric view of a shared vehicle for use in a user-distributed shared vehicle system including an enlarged isometric view of a user interface “accessory pack” for the vehicle.

FIG. 4 is a schematic diagram of an indication system to identify the availability of a shared vehicle for use in an implementation of a user-distributed shared vehicle system.

FIG. 5 is a flow diagram of an implementation of a system of rules for determining a priority of availability between shared vehicles at a station for rental or access for use.

FIG. 6 is a schematic diagram of an implementation of a display system for indicating to users of a user-distributed shared vehicle system the operating range and return deadline for a shared vehicle in the system.

FIG. 7 is a schematic diagram of a general purpose computer system that may be variously implemented in the user-distributed shared vehicle system in a vehicle accessory pack, a station kiosk, and as a server and database computer for system-wide control.

### DETAILED DESCRIPTION

Most mobility patterns are cyclical in nature. Commuters tend to take the same mobility mode to work every day and return at the end of the day using the same mode. Additionally, arrival and departure times are predictable or generally known from day to day. Rather than hampering potential users by a need to return a shared vehicle promptly to a central rental station, it is possible to allow a user to rent a vehicle for the first leg of their round-trip rental in the morning from a centrally located rental station. Once this “distribution-user” arrives at a desired destination, the user could secure the vehicle at a designated day station near the workplace with the knowledge that at the end of the workday, the vehicle rental system would ensure that a similar vehicle would be available at the same day station for the distribution-user's return trip. To facilitate the ability to secure a vehicle at a day station, the vehicle may be configured to attach to the day station. Through a locking system and a user identification system, day station users may be identified and the vehicle unlocked to facilitate vehicle usage. During the middle of the day, the distribution-user that rode the vehicle to the day station would not be financially responsible for the vehicle making it more cost effective to take a shared vehicle to commute to the workplace.

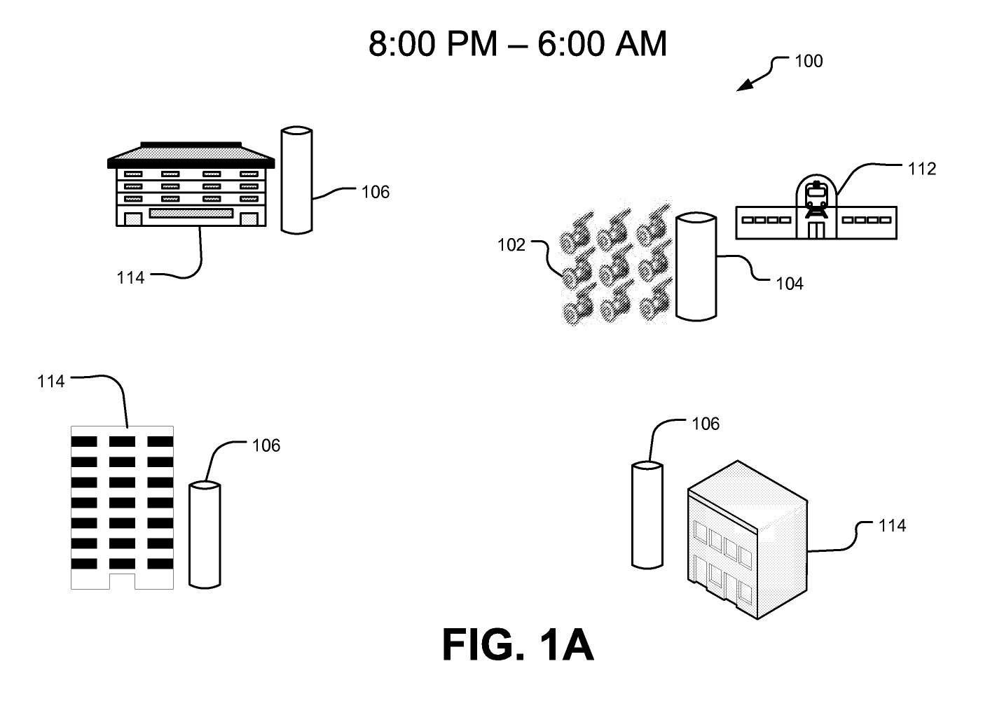

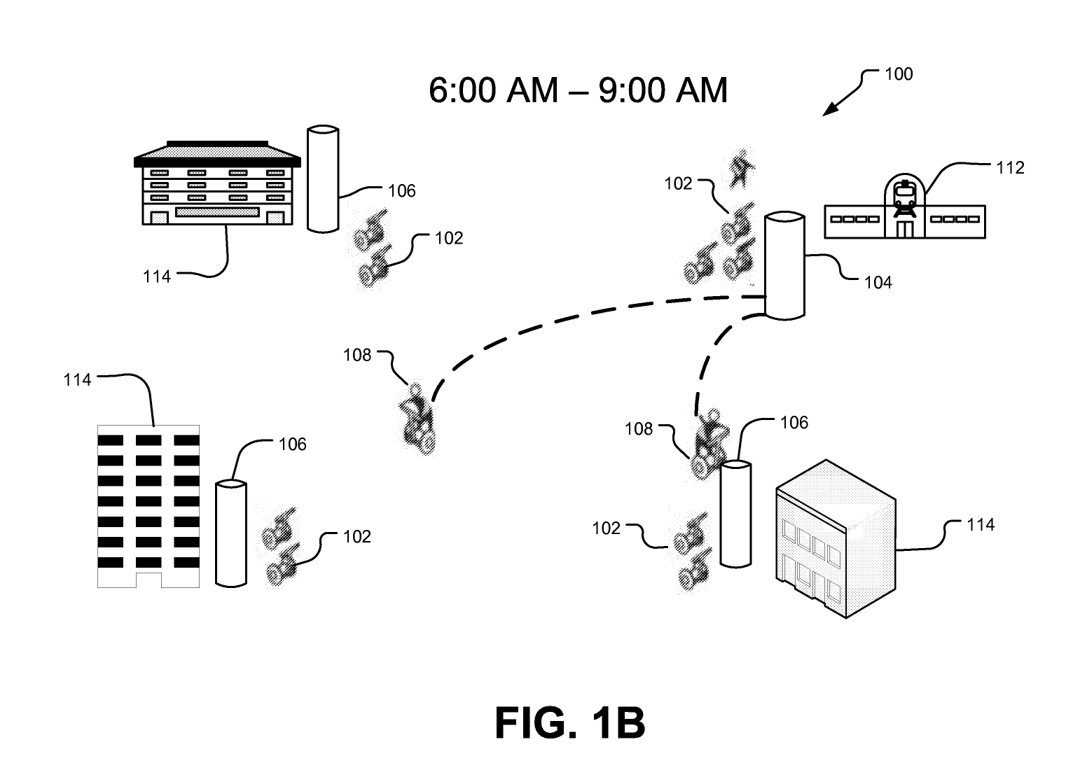

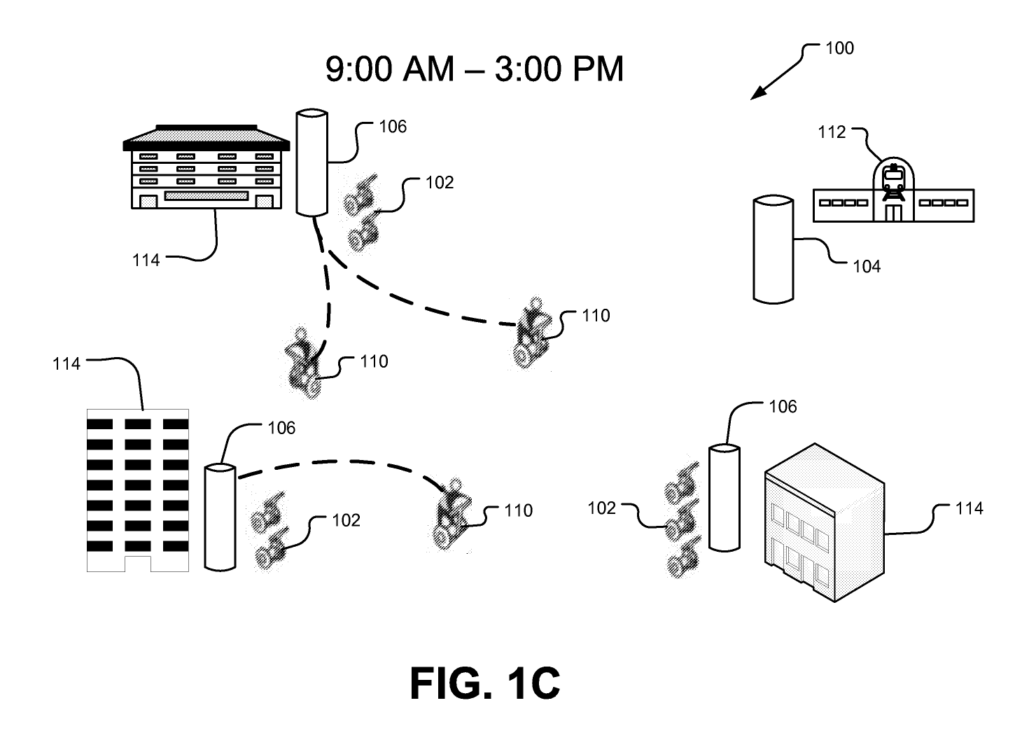

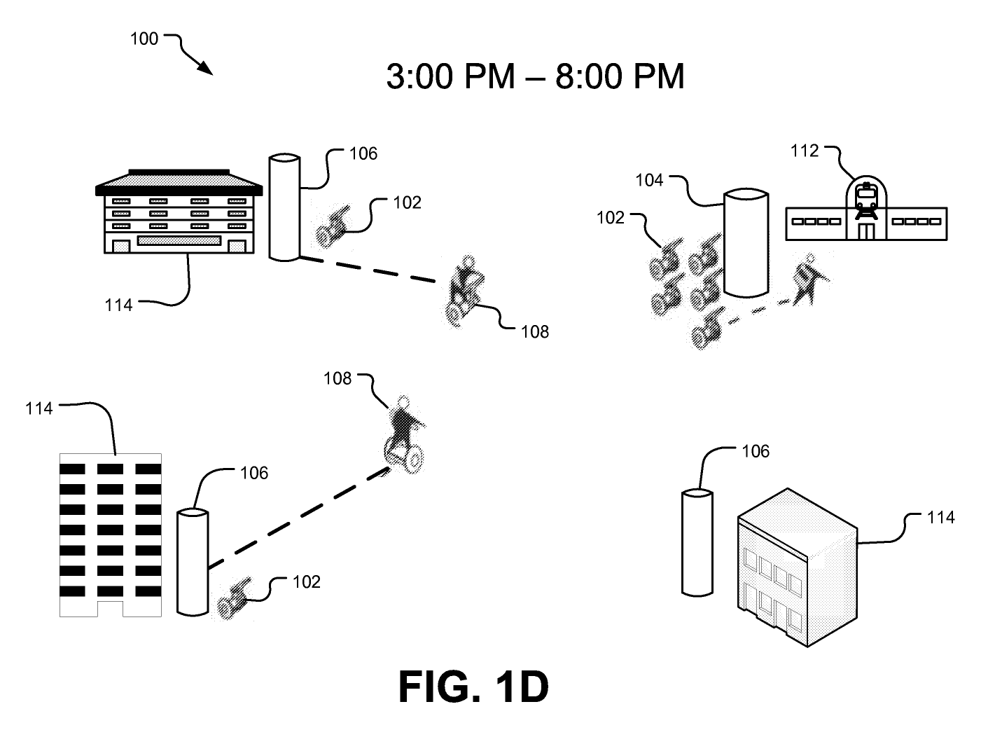

A representative implementation of a user-distributed shared vehicle system 100 is shown in FIGS. 1A-1D. In FIG. 1A, an allocation of the resources of the system 100 at off-peak hours, e.g., overnight between 8:00 p.m. and 6:00 a.m. is represented. Most if not all of the shared vehicles 102 are located at a central home-station 104 where they can be easily secured overnight and located for ease of distribution during morning commuting hours. The central home-station 104 for the user-distributed shared vehicle system 100 may be located at or near a significant mass transit hub 112, e.g., a commuter rail station. There are no vehicles located at any of the day-stations 106 during this period, however, in other implementations some vehicles may remain at the day-stations 106 during this period.

As shown in FIG. 1B, during rush hour between 6:00 a.m. and 9:00 a.m., distribution-users arriving at the mass transit hub 112 may disembark and walk to the central home-station 104 to select a shared vehicle 102 to ride to one of several day-stations 106 associated with the central home-station 104. The day-stations 106 may be located near significant employment centers 114, e.g., individual office buildings or office parks, which are the ultimate destinations of most commuters disembarking from the mass transit hub 112. In this implementation the mass transit commuters become the distribution-users 108 that effectively distribute the shared vehicles 102 during the daytime hours of operations. This distribution of the shared vehicles to the day-stations 106 allows other users, i.e., day-users 110, the opportunity to rent the shared vehicle 102 at a more convenient location than the nearest train, bus, or other mass transit station 112 as shown in FIG. 1C.

This built-in distribution “service” offers value to the vehicle rental system 100 by distributing the system's shared vehicles 102 during the day to locations more likely to have short-term rental needs. A reduced monetary rate charged to users who are regular distribution-users 108 may encourage this type of distribution service. Additionally companies that are required to document employee reductions of single car commutes to work can use the system's billing process to prove the use of alternative transportation to their workplace. For example, the California Environmental Quality Act and other transportation related programs could issue mitigation credits to employers based upon employee use of public transportation and a shared vehicle system.

Once the distribution-users 108 have distributed their vehicles 102 at the day stations 106, the shared vehicles 102 are now available for additional rental by day-users 110 as shown in FIG. 1C. Since the vehicles at the day station 106 need to be available for the distribution-users' 108 return trips at the end of the workday as depicted in FIG. 1D, it may be a requirement that the vehicles 102 are only rented as round trip rentals from the day station 106 with a specific return time. Requiring the day-station rental to be a round-trip rental ensures that the day station 106 remains balanced throughout the day. The goal is to result in the correct number of vehicles 102 at the end of the day at the day-stations 106 to allow all the distribution-users 108 to return to the central home-station 104 via shared vehicles 102. A specific return time for all day station 106 round-trip rentals by day-users 110 may be displayed on the vehicle 102 during the rental to further ensure that all shared vehicles 102 will be available for the distribution-users 108 return leg back to the central rental station 104 at the end of the day.

An incentive may be implemented at the day station 106 rental system to cover the incurred inconvenience to the distribution-user 108 when a day station round-trip user 110 doesn't return the vehicle 102 by the specified return time. Since a distribution-user 108 will be required to take an alternative mobility mode back to the central-home-station 104 if a day station vehicle is not returned on time, the shared vehicle rental system 100 may reimburse the expense incurred by the distribution-user 108 for having to use an alternative mobility mode (e.g., a taxi cab, a pedi-cab, or a bus). The shared vehicle rental system 100 will know which day-user 110 was late to return to the day station 106 and may issue a fine associated with the late day station return. The fine may be based upon the cost of taking a taxi cab from the day station 106 to the central home-station 104 as well as the cost of paying a maintenance person to shuttle the late-returned vehicle back to the central-home-station 104 to ensure sufficient number of vehicles 102 for the commute the next day.

A number of support-oriented benefits are achieved by having all of the vehicles return to a centralized location in the evening that make it more cost effective to implement the day station vehicle rental system architecture 100 when compared to other system models. It is easier to perform maintenance on the entire fleet of shared vehicles with all the shared vehicles 102 in a central location. Tire changes, software updates, and general shared vehicle 102 cleaning can be done from a central maintenance office located at the central-home-station 104 which is more cost effective than supporting a mobile maintenance van or a crew using a vehicle to bring shared vehicles 102 to and from a maintenance facility.

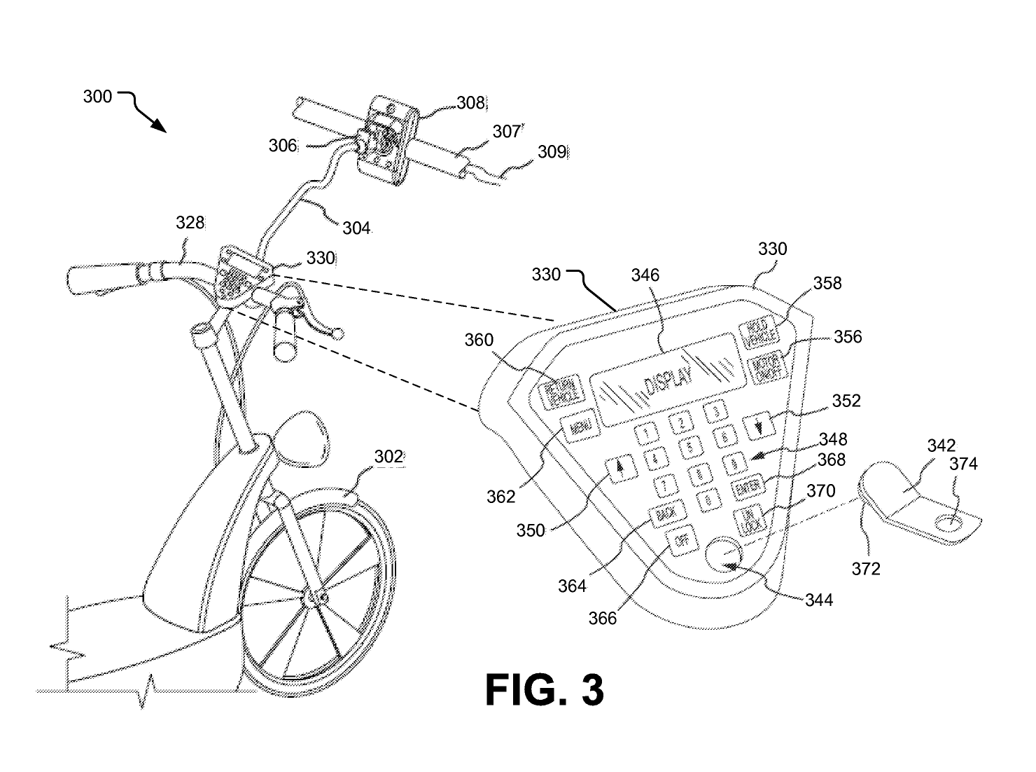

Additionally the amount of security infrastructure needed for the entire system 100 is also greatly reduced in the day-station architecture of the user-distributed shared vehicle system 100 since day-stations can use a light-duty security system. For example, and as further described with respect to FIG. 3, a computer controlled/monitored electronic lock can notify the system manager when a vehicle has been forcibly removed from the day station's light duty security system. A real-time warning of a possible vehicle theft does not require the same level of fencing and access control that a nighttime vehicle storage station requires. Additionally locations of the day-stations 106 may be positioned in high foot traffic locations with a high level of visibility where there is less need for fences or access control gates surrounding the vehicles parked at the day-stations 106. By reducing security infrastructure needed at the day stations 106 the cost of implementing the distributed day stations 106 is reduced, making it more cost effective to set up day stations 106 when compared to an overnight vehicle storage facility. Reduction of day-station cost results in lower system implementation cost and ultimately lower vehicle rental costs.

The user-distributed shared vehicle system described above enables a mass transit hub 112, e.g., a train station, to serve a larger geographical area then one which a distribution-user 108 would normally deem too far from the workplace 114 to walk from the mass transit hub 112. This architecture for the shared vehicle system 100 can increase the number of users that could conveniently take rapid transit to and from the workplace 114 as it would be feasible for a distribution-user 108 to travel several miles from the mass transit hub 112 to the workplace 114 on a shared electric vehicle 102. Once distributed throughout the surrounding area, it is much more likely that a potential day-user 108 will find it convenient to rent a shared vehicle 102 at a nearby day-station 106 when compared to the mass transit hub 112.

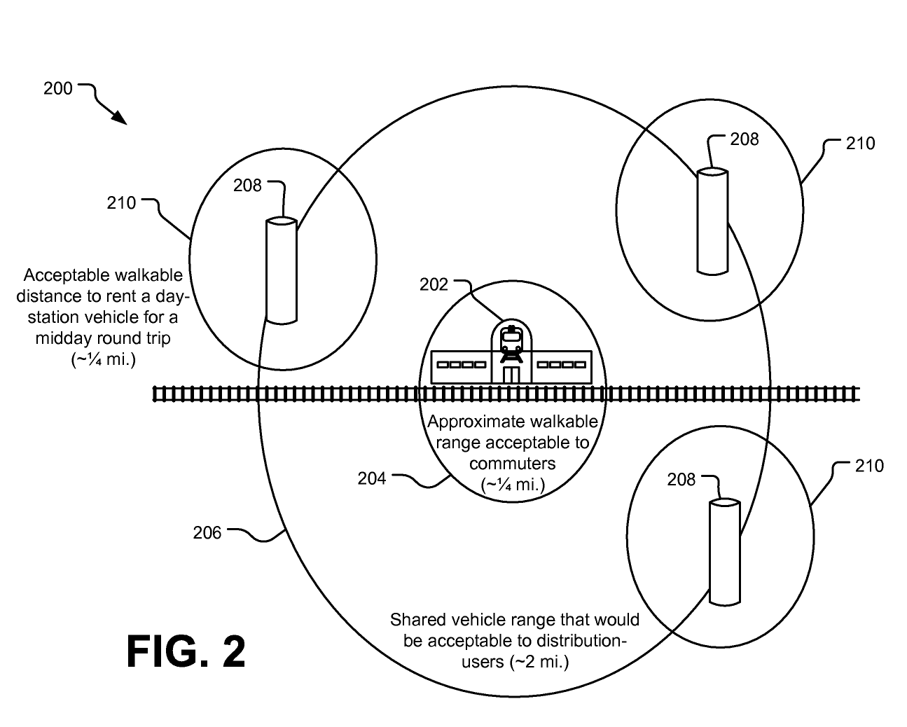

For example, as shown in FIG. 2, it may be acceptable for commuters disembarking from a mass transit hub 202 to walk to an office building or other place of employment within about a ¼ mile radius 204 of the mass transit hub 202. However, if the distance from the transit station 202 to office exceeds this relatively short radius 204, commuters are less inclined to use the mass transit system because of the length of time it takes to walk the “last mile.” However, if a personal electric vehicle or other type of shared vehicle were available for rental from a location near the mass transit hub 202, the commuter may be much more inclined to use a combination of mass transit and shared vehicle because the travel time from the mass transit hub 202 to a day-station 208 near an office, e.g., within about a 2 mile radius 206, would be acceptable. Similarly, it may be acceptable for day-users in the community to walk to an office building or other place hosting a day-station within about a ¼ mile radius 204 of the day-users origination point. However, if the distance from the day-user to the day-station exceeds this relatively short radius 210, e.g., about a ¼ mile distance, the potential day-user may be less inclined to use a shared vehicle for short trips as opposed to taking a taxi cab or driving a car.

The concept of the user-distributed shared vehicle system can be extrapolated into a multiple user-distributed shared vehicle system. The multiple user-distributed shared vehicle system resembles a one-way rental system in the fact that the user is free to secure a shared vehicle at any local day station (and subsequently make it available for additional time limited rentals to other users) with the caveat that each day-user will return the shared vehicle rental to the particular day station that they initiated the shared vehicle rental by an agreed upon time of day. This type of rental system may be called a “Round Trip By Time X” rental system, where the day-user is responsible for the shared vehicle while riding the shared vehicle and responsible to return the shared vehicle back to the original day station of rental by a certain time of day.

This arrangement allows the day-user the flexibility to leave the vehicle at any nearby day station and avoid paying for the vehicle when not being directly used. This arrangement also allows the system to preserve the system balancing benefits of round trip rentals while avoiding the utilization penalty associated with day-users having to pay for a shared vehicle when the user is not directly using it. In one implementation of the multiple user-distributed shared vehicle system, the shared vehicle may show the day-user the time of day required to return the shared vehicle making it more likely that each day-user would know when to return the shared vehicle to avoid a penalty.

There are numerous methods of implementing a user-distributed shared vehicle system that span in technology from paying rental station attendants at the central-home-station and day stations to keep track of the system's operational status with cell phones, pencil, and paper to a totally automated system that relies upon mechanical vehicle security devices and wireless Internet communication links between day stations and the central-home-station. Several exemplary methods of implementing a user-distributed shared vehicle system are further described herein where the key system features are described to enable the system to operate as desired.

Users of the user-distributed shared vehicle system may be enlisted through a number of methods including, but not limited to, Internet registration from a user's computer, a kiosk computer located at a shared vehicle rental station, or interpersonal data exchange with a shared rental vehicle system employee. User account data may be stored in a central server computer, at a station computer on a local are network (LAN) or on a kiosk computer located at a stand-alone shared vehicle rental station. The computer system that holds the user data may also be actively involved in scheduling vehicle rentals and returns. A user identification device or user ID device, for example, a magnetic swipe card, a RFID card, or an iButton, or a Bluetooth enabled mobile phone or other medium capable of uniquely identifying one user from another may be issued to each user to provide a controlled method of identifying users of the system. As an additional security feature a user may be required to enter a Personal Identification Number or PIN when renting a shared vehicle.

The shared vehicle itself may have the ability to read the user ID device and communicate to a station computer either via a wired or wireless communication link enabling each vehicle to serve as the rental transaction site or a kiosk at the rental vehicle station could be used to serve as the rental transaction site. The shared vehicle may also have a data entry keypad and may have a display that is easily read by the user. The shared vehicle may also be equipped with a locking device that interfaces with locking receptacles at the rental station and that are under control of the rental station.

As shown in FIG. 3, a length of electrical charge cord 304 between the vehicle and the locking receptacle at a station may be fixed to the frame or body of the vehicle. In one embodiment, the electrical charge cord 304 and a connector plug 306 may also include serial data wires and an electro-magnetic shield integrated into the connector plug 306 and charge cord 304 if desirable to communicate through a wired link between the vehicle 302 and the lock-charge port 308. The lock-charge port 308 is mounted on a rack 307 through which power and data wires 309 may be run to provide power and communication links to the lock charge port 308.

The charge cord 304 may also integrate a security cable (not shown) that may provide a reasonable level of physical security between the vehicle 302 and the lock-charge port 308 when the vehicle 302 is plugged into a lock-charge port 308. The security cable in the charge cord 304 may be mechanically attached to the connector plug 306 in such a manner that all forces placed on the security cable 310 are transferred into the connector plug 306. The connector plug 306 may be configured to act as a latch to interface with a locking mechanism residing in the lock-charge port 308 such that when the latch is locked within the locking mechanism all mechanical forces experienced by the security cable in the charge cord 304 may be mechanically transferred from the security cable to the latch structure of the connector plug 306. The latch structure of the connection plug 306 may then transfer the encountered forces to the locking mechanism in the charge port 308 without interrupting the power or data passing between the lock-charge port 308 and the vehicle 302.

A vehicle accessory pack (VAP) 330, also referred to as a rental accessory pack (RAP), is an exemplary implementation of a control and display device adapted to personal vehicles and personal electric vehicles to allow them to be checked-out and shared in an automated manner such as at a rental station or kiosk. An exemplary interface for a VAP 330 is depicted in detail in FIG. 3. The VAP 330 may be configured in many ways including the illustrations as shown herein where the housing or shroud is customized to fit the handlebars 328 of the vehicle 302. The display and control panel provide multiple functions as described herein, and may be implemented in a variety of ways in addition to or beyond those described, including changing the basic shape and appearance of the panel.

In the embodiment shown in FIG. 3, a display 346 such as an LCD is surrounded by a variety of labeled touch-buttons. Alternatively a touch panel display could be used where the functions performed by the labeled buttons would be replaced by graphics written to the display by software from the embedded microprocessor in the VAP 330, and the user responses could be mapped to X-Y coordinates on the touch panel. Similarly, the functions can be renamed or changed in whatever manner needed for transferring information to the user or receiving instructions therefrom. In a simple example, the language and character set might be altered to match the language and culture of the intended user.

One implementation of the VAP control panel is shown in FIG. 3. The circular feature at the bottom center of the panel is a reader 344 for an electronic identification device 342 known as an iButton® or GoKey™. Such an identification device is optional, and may come in many forms which include but are not limited to the iButton, a magnetic card reader, an RFID chip, a barcode reader, etc. Alternatively, the user may be asked to enter an identification number on the numeric keypad rather than using an electronic identification device. The ID device 342 as shown has a button-shaped RFID interface 372 and defines an aperture 374 in the body sized to fit on a key ring.

The VAP 330 has a display 346 that may be an alphanumeric and/or graphics display panel of LCD or other technology. The display may be color or monochrome and could include a touch screen interface. The VAP 330 also provides a keypad 348, in this case a typical 10-key numeric entry pad is shown, although expanded alphanumeric versions are possible. The keypad 348 may be used to enter a unique identification code, e.g., the numeric equivalent to a barcode and PIN numbers for access and authorization purposes.

In addition to the standard keypad, several special purpose keys or buttons may be provided. A first button is labeled as a “Return Vehicle” button 360. One feature of the disclosed technology is the ability to return the vehicle from rental status without having to dock the vehicle at a docking station. Automated bicycle rental systems such as the Velib system in Paris, France have been known to frustrate users when they attempt to return a rented vehicle to a docking kiosk where there are no available docking stations. In contrast, the technology disclosed herein may a utilize wireless communication configuration and allow the user to employ the “self-lock” feature described herein to secure the vehicle to a local pole, tree, or other appropriate point near the return station and then press the “Return Vehicle” button 360.

At that point the user's rental will be terminated, the status of the vehicle will be assessed, and a “Ready to Rent” message or “Available” indicator, as further described below, may be displayed so that the vehicle may be rented by another user. This feature allows vehicles to be rented and returned at virtually any location within wireless communication range without relying upon an available open docking station. Note that the wireless communication range can be global in scope if satellite communications are utilized or the wireless network is connected to a global network such as the Internet. In such cases, vehicle return and rental may be implemented on each individual vehicle virtually anywhere, with or without docking stations. In local systems where docking stations are the preferred return location, users may be incentivized to rent vehicles that are not attached to a docking station through monetary advantage (e.g., a reduced rate or free rental period), plus helping balance the overall shared vehicle system by moving excess vehicles to other locations where docking stations are available.

A second feature is provided under the “Hold Vehicle” button 358. Another feature disclosed herein is the ability to place a vehicle on “hold.” Using this feature, the vehicle may be placed in a docking station or self-locked at a convenient location but held for the current user so that the vehicle may not be taken by a new user. In one embodiment of this feature, after placing the vehicle at a docking station or self locking the vehicle and pressing the “Hold Vehicle” button 358 the VAP display will prompt the user to enter a number of minutes. For the period of time entered, the vehicle will be held for the current user and if not taken by the current user by the end of the time period, may automatically display a “Ready to Rent” message or similar indicator making the vehicle available for any new user. The “Ready to Rent” display may also indicate the number of miles of range expected from the current state of charge for a PEV. The “Hold Vehicle” feature may also be initiated remotely. For example, a shared vehicle system subscriber might access the vehicle status at a current location using a wireless PDA or similar device. Once a desired vehicle is located, the subscriber may select “Hold Vehicle” so that the vehicle is waiting for a prescribed period of minutes for the subscriber's arrival.

Additional buttons may perform more display specific functions. For example, a “Menu” button 362 may bring up a menu of options on the display 346 as defined by the operating software. In an electric vehicle a “Motor Off” pushbutton 356 may turn a motor assist function on or off. For example, electric bicycles commonly have the capability of being operated in a manual pedal mode. This “Motor Off” button 356 allows motor assist to be enabled or disabled at any time during the ride. Increase ↑ and decrease ↓ symbol buttons 350, 352 may be provided to increase and decrease a value as set on the display 346. For example, the “Menu” button 362 may allow these symbols to be assigned to control the maximum speed of a vehicle under electric power. They may also be used under “Menu” options to increase or decrease values for entry (e.g., number of minutes to hold the vehicle).

An “Enter” button 368 may be used to complete the entry of a sequence of numerals or other data. A “Back” button 364 may be provided to clear a previous character or go back to a previous screen as assigned by software. An “Off” button 366 may be provided to turn off the VAP 330 and disable the electric motor in the vehicle. A user generally must enter an identification device or number and PIN to regain access to the VAP 330. This “Off” function may be programmed in a variety of ways. For example, if the vehicle is not docked or self-locked when the “Off” button is activated, the display 346 may request that the user lock the vehicle in some manner before disabling the VAP 330. An “Unlock” button may be used to begin a rental sequence or take a vehicle off “Hold.” When pressed, the “Unlock” button may cause the display 346 to request the user to provide an identification and PIN before enabling the vehicle for use.

In addition to the buttons and features described above, a wide variety of additional enhancements may be implemented including, but not limited to, such features as GPS-enabled graphics, cell phone communications, location-based services, local and global help functions, alarms and control of vehicle-specific functions (e.g., headlights, tail lights, turn signals), and more.

In one implementation, the user may present an ID device to the ID device reader 344 on the vehicle's VAP 330 to be electronically identified. The user information display 346 or bright LED prompting lights on the VAP 330 may then request the user type in a PIN using the VAP's keypad 348. The user would then respond by typing in the PIN. The embedded microprocessor could then pre-screen the user-presented data to determine if the ID device data or ID code was received within an appropriate data format and that the PIN contained the correct number of digits. If the received user input data was not in the correct format, the embedded processor may instruct the user to re-attempt the electronic identification process. If the ID device data and user's entered PIN were found to be correctly formatted, the VAP 330 may then communicate the ID device data, PIN data, and selected vehicle data to the kiosk computer, through a wired or wireless communication link.

The kiosk computer may determine the status of the user's account and ensure the vehicle selected by the user is appropriate for the age and skill level of the user. If the user were too young or not sufficiently skilled to rent the selected vehicle, then the kiosk computer database may communicate to the VAP 330 that the vehicle is not an appropriate vehicle for the user and the VAP's user information display could then prompt the user to select a more appropriate vehicle. Other reasons for denying a vehicle rental could include an incorrect PIN, an unidentifiable ID device code, an outstanding balance due on a user's account, a prior and still current vehicle rental by the user requesting to select an additional vehicle, the selected vehicle is not available for rental, the ID device has been deactivated because of being reported lost or stolen, or any other reason that could be useful when managing an electric vehicle fleet. All of the above reasons to deny a rental may be presented to the user via the user information display 346 or an LED display configuration. Such a rental system is described in detail in the “Share vehicle management system” application previously referenced and incorporated herein.

The following exemplary scenarios are presented to describe how the rental system works. Suppose a user initiates rental of a shared vehicle secured at a central station (e.g., a train station, a central bus station, or other transportation hub where people typically change mobility modes). The shared vehicle system database may recognize the user as a regular distribution-user at his normal central rental station in the morning where the user usually takes the shared vehicle for the first leg of a rental. A user already known by the shared vehicle system can present a user ID device to an ID device reader on the shared vehicle desired for rental. The shared vehicle rental system may further request that the user input a PIN to verify that the user is authorized to use the user ID device. Once the correct PIN is verified, the shared vehicle rental system may confirm via a user interfaced display on the vehicle that the user wishes to take the shared vehicle to a particular day station and leave it there during the day. Alternatively, if the user indicates through the user interface he is not to take the shared vehicle to a workplace day station, the vehicle display may offer other vehicle rental options typical of the surrounding operational environment.

In this example, the user agrees (via data entry on the vehicle keypad) to be a distribution-user by traveling to work, but on this particular day the user has a doctor's appointment in the afternoon and is leaving work early. So when the user agrees to be a distribution-user, the shared vehicle rental system requests the time of day that the distribution-user would like to initiate the second leg of the rental via the shared vehicle's display. If the distribution-user wishes to catch the 3:15 train, the user may enter 3:00 PM in the vehicle's keypad. The shared vehicle's display would then show the data entered and request any corrections if necessary.

Once the distribution-user has been correctly identified and the type of rental transaction has been determined, the shared vehicle's security link to the station is released and the shared vehicle is now turned on and available to distribution-user. Numerous methods of implementing the above shared vehicle system functions in the “Shared vehicle management system” application referenced above. The distribution-user may take the shared vehicle to several stops along the way and may choose to lock the vehicle to itself or secure it by other means before arriving at his particular day station. Only the distribution-user's ID device can be used to activate the shared vehicle after being turned off during the rental via the vehicle's ID device reader. When the distribution-user arrives at the day station, the distribution-user can secure the shared vehicle using a security device that interfaces with a receptacle at the day station to form a secure attachment between the day station and shared vehicle. Once the shared vehicle is docked at the day station, the distribution-user is no longer financially responsible for the shared vehicle until 3:00 PM when he plans to return the shared vehicle to the central-home-station.

Continuing this example of the system in operation, a few minutes after the distribution-user brings the shared vehicle to the day station, another known user of the shared vehicle system decides to rent a vehicle from the day station to pick up some supplies at a local stationery store. Once this day-user is identified by her ID device and PIN via the vehicle's ID device reader and keypad, the user may be informed via the display on the shared vehicle that the selected vehicle must be returned to the day station by 3:00 PM in order to avoid a late charge penalty. The user can agree to the required rental return time by making entries through the shared vehicle's keypad. In an alternative embodiment, the keypad may be part of the charging/locking receptacle at the station, eliminating the need to have a keypad on the vehicle. Upon a successful rental transaction, the day station releases the security cable or other locking device and the shared vehicle is turned on allowing the day-user to take the vehicle on her intended journey.

To continue this example, suppose that during the trip to the stationery store, the day-user meets a friend riding another shared vehicle from a neighboring workplace day station. The friend wants the day-user to accompany her to the friend's workplace. Upon arrival at this alternate day station, the day-user attempts to return her shared vehicle at this alternate workplace day station. However, the system notifies the day-user that she is not allowed to return the shared vehicle to the alternate day station because of her agreement to return it to her workplace day station for later user by the distribution-user. This notification may be provided by display messages, warning sounds, flashing lights, or other attention communications. If the day-user attempts to secure the shared vehicle to the alternate day station the day station may refuse to lock the shared vehicle. The shared vehicle's display and alerts may indicate that this was not the correct day station for return and may inform the day-user that she needs to return the shared vehicle to the day station where she rented the shared vehicle from initially. The system may also communicate to the day-user that if she would like to stop at this location, she may turn the vehicle off and secure it to a stationary item using a self locking feature, for example, as described in the “Shared vehicle management system” application referenced above.

This type of intelligence in the shared vehicle may be implemented in several different manners. For example, a wired or a wireless communication link could be established between the shared vehicle attempting to be returned and the day station whenever the locking receptacle at a day station is connected with the shared vehicle. The day station may look up to the status of the vehicle through a central database, learn that the shared vehicle is designated for return to another day station and communicate to the share vehicle that the user is attempting to return the shared vehicle to the wrong day station. Alternatively, the shared vehicle's embedded microprocessor may recognize that it is being attached to an incorrect day station upon identifying the day station through the communication link. In either implementation, of which more permutations are possible, the shared vehicle's embedded microprocessor may hold in memory the identification of which day station it needs to be the returned to and receive data through the wired or wireless link that it was not being returned to the correct day station. The shared vehicle's embedded microprocessor and display may then be actively involved in alerting the user to the problem associated with returning a vehicle to an incorrect day station.

Continuing with the example, upon completion of the day-user's impromptu meeting, the day-user may use her ID device to release the self-locking feature of the shared vehicle and return to her workplace day station where the shared vehicle becomes available for additional time-limited rentals until 3:00 PM. If during the course of the day the distribution-user's plans change, it may be possible for the distribution-user to log onto the shared vehicle system website and alter the return time to a different time of day. If conflicts exist at that point, the website may communicate updates and attempt to accommodate the distribution-users changed plans as different vehicles arrive and leave the day station. If the distribution-user indicates an inability to return the vehicle to the central-home-station, the system may allow the distribution-user to cancel the return leg of the rental for a penalty charge. Thus, if at the end of the day the shared vehicle is still at the day station, any registered user that wants to go to the train station can use the stranded shared vehicle to get to the central-home-station, perhaps free of charge to incent the return of the shared vehicle to the central-home-station. This policy would further reduce the burden of balancing the system with minimal loss of revenue due to the penalty charge placed on the original distribution-user.

In an alternate scenario, the distribution-user does not change his plans and arrives a few minutes before 3:00 PM to pick up the shared vehicle. There may be a number of shared vehicles at the day station with displays indicating that they are available for a round trip rental of less than 1 hour. This indicates that there will be a number of distribution-users that need to plan to begin the return leg of their rental by 4:00. A reserved indicator next to the distribution user's shared vehicle may be illuminated to indicate that the shared vehicle is not available to initiate a rental but that the vehicle is reserved for a user to complete a return leg of a rental or to meet a reservation need. The distribution-user may place his ID device on the shared vehicle reader. The vehicle rental system recognizes that this is the distribution-user that will return the shared vehicle to the home station and release the security interface at the day station and to allow the distribution-user to remove the shared vehicle from the receptacle to travel to the central-home-station.

Continuing with an alternate example, suppose that during the entire time that the day-user was in the impromptu meeting she was paying for the shared vehicle without actually using the shared vehicle. In an alternate implementation, the shared vehicle rental system described above may be configured to allow nested day station rentals. In this configuration, the day-user at the alternate workplace day station may know that she will stay for at least 2 hours. Rather than pay for the shared vehicle to sit secured but idle in one location for two hours, a nested day station rental system may allow the day-user to secure the shared vehicle to the alternate day station from the rental origination location for that time period for us by others. In this type of configuration, also referred to as a “Round Trip By Time X” rental system, the day station rental system via the shared vehicle's display may ask the day-user when the vehicle would be needed to complete the second return leg of the rental. If the day-user enters a time of day via the vehicle's keypad later than when another user needs the shared vehicle to complete another rental return leg (past 3:00 PM for the distribution-user in our example) the day station rental system via the shared vehicle's display would deny the request to secure the shared vehicle at that charging receptacle. The display may state that other users need the shared vehicle before the day-user's intended return time.

If on the other hand the day-user states that she would return the shared vehicle in two hours, the day station's shared vehicle rental system and the shared vehicle's embedded microprocessor would recognize there is plenty of time for the day-user to return the shared vehicle to the original day station to provide the original distribution-user a vehicle to return to the hone-station by 3:00 PM. The system may then allow the day-user to secure the shared vehicle at the different day station. This allows the day-user to rely upon the fact that the system will provide the day-user with a shared vehicle when the day-user needs it for the return trip and that day-user does not need to pay for the vehicle rental during the time that the day-user is at the alternate day station. The shared vehicle system may decide to make the shared vehicle available for rental during the two hours that the day-user is at the alternate day station. If another day-user wants to rent the shared vehicle, the shared vehicle's interface will require that the next user must return the shared vehicle to the second day station before the first day-user's two hour meeting is over. The system may actually require an earlier return to allow sufficient time for battery charging. The day station rental system and the shared vehicle's embedded microprocessor may track the time it is manage the vehicle's reservation schedule throughout the day and may display any available penalty-free rental time remaining to potential rental users. The shared vehicle's registration schedule may be managed by storing each user's entered data during rental transactions in a central server as communicated by the shared vehicle over a communication link or the reservation data may be kept in the shared vehicle's embedded microprocessor and local memory. The shared vehicle's display may be programmed to warn the current day-user that the shared vehicle needs to be returned to the day station by a certain time.

If a day-user does decide to rent the shared vehicle while the first day-user is in her meeting and does not return it on time, the tardy second day-user may have to pay a substantial late fee sufficient to compensate for the cost to return the first day-user to her office via an alternate mode of transportation (e.g., a taxi) and possibly cover the expense of having a system operator shuttle the tardy shared vehicle back to the original day station where the first day-user initiated her rental. When the first day-user completes her 2-hour meeting, she will want to complete the last leg of her rental, which is basically a scheduled one-way rental. If there are no shared vehicles at the alternate workplace day station (e.g., because the second day-user has not returned the shared vehicle on time), the first day-user will need to access the registration system at the alternate workplace day station, e.g., via a kiosk, or could use her telephone, to notify the vehicle rental system that there are no vehicles available for her to complete the last leg of her rental. An Internet connected computer with a monitor and keyboard may be provided at each day station for kiosk interface with the rental system. The kiosk computer may be capable of reading the first day-user's ID device, accessing the rental system's central computer through a wired or wireless communication link, and directing a course of action for accessing alternate mobility modes, e.g., like requesting a prepaid cab and giving the first day-user directions to a location for pick up by the cab.

Alternatively, if there are shared vehicles available at the alternate workplace day station, the day-users could request to take one of those other shared vehicles to return to the original workplace day station. This would allow the day-user to complete the second leg of her rental and provide the original day station with the correct number of shared vehicles to complete the return legs of the distribution-users. The alternate day station from which the day-user takes the shared vehicle would have a one-vehicle deficit until the tardy second day-user returns from his rental. One way to view this situation is that there will always be one day-station shy of one shared vehicle until the tardy vehicle is returned to the correct day-station to balance the system. The day-station that is one shared vehicle shy should be the station where the tardy second day-user has agreed to return the shared vehicle.

Since the shared vehicle rental system is able to communicate via the Internet or through a wireless communication link between the stations it is possible to determine whether the tardy user's vehicle is secured to some other day-station or has been returned at the central home-station. If it is determined that the tardy vehicle is not at a station, it may be a good assumption to believe the tardy vehicle is on its way back to the correct rental station. If on the other hand it is known the tardy vehicle is secured to another station in the system, it is possible to configure the shared vehicle rental system to inform the tardy second day-user upon attempting to take the final leg of his rental that in order to avoid additional penalties it is requested that the second day-user return the shared vehicle to whatever station will balance the system (e.g., like the day station where the original distribution-user will need the tardy vehicle at 3:00 PM), assuming the first day-user with the 2-hour impromptu meeting used an alternate mode of transportation to return due to a lack of shared vehicles at the alternate day-station.

With the Round Trip By Time X day station rental, if the tardy user is so late that the original distribution-user is unable to complete the last leg of his rental by 3:00 PM, then the tardy user would be charged for disrupting two nested reservations. The shared vehicle can communicate through the vehicle's interface to the tardy second day-user which day station the second day-user needs to return the shared vehicle to avoid disrupting other nested return legs rentals. The shared vehicle may be instructed to provide this information to the second day-user either through a wireless communication link between the shared vehicle and a nearby day-station or through a wired link at any day-station that the vehicle is secured. This communication may give the tardy user a sense that the system and shared vehicle are cooperating with the tardy user even if late fees are to be charged for the nested rentals disrupted by the tardy behavior. However, at the same time by having the shared vehicle's interface direct the tardy user to the day-station where the vehicle should be located to satisfy the next nested leg rental, this enables a cost considerate tardy user to rebalance the system that was taken out of balance by the tardy user. The overall penalty charge to the tardy user may be reduced while at the same time reducing the tardy user's impact on others relying upon the nested user-distributed shared vehicle system.

These implementation examples are based upon only a few vehicles being located at each day-station. As the number of vehicles increases at each day-station it becomes less likely that any one tardy user will inconvenience a user wanting to complete the last leg of their rental. This is due to the fact that all any shared vehicle at a day-station can be allocated to any user making a request. So if in the above example, the tardy second day-user does not return the shared vehicle in time for the first day-user after the 2-hour impromptu meeting, the firs-day user may take another vehicle at the alternate workplace day-station with no sense of inconvenience and no further system imbalance. The particular shared vehicle originally used by the first day-user may not be available for the return trip to the original workplace day-station, but the first day-user can use another vehicle to satisfy her mobility needs and at the same time satisfy the need of the original day-station to keep the system balanced.

In this scenario, the tardy user really would not be inconveniencing any of the distribution-users until the last distribution-user attempts to take a shared vehicle from the original day-station to the central home-station, which could be hours after the promised return by the tardy user, and which by that time the tardy user might have already returned the shared vehicle. In fact the penalties imposed upon the tardy second day-user may not be needed to transport stranded users to their original day stations as in the example described above, but rather the penalties and fees may be a source of income to the mobility service provider to supplement other balancing situations that arise. Alternatively, late return penalties may be based upon the tardy user causing a disruption of service in any way. However, if it becomes known that late fees are not always billed to a tardy user, it may reduce the effectiveness of penalties to encourage users to return the shared vehicle at the agreed upon return time.

The following is another example of how the rental system may operate to minimize any adverse affects of late returned shared vehicles. In this example, a station-to-home user lives near a home-station, e.g., a train station, but which is too far a walk. The user frequently arranges an overnight rental with an agreement that he will bring the shared vehicle back by 8:00 AM the next morning on his train-based commute to work. One day the user's child gets sick and he can't start his daily commute until 9:30 AM. Since the train station has many shared vehicles available in the morning for distribution-users to take to their respective day stations, it may be 10:00 AM before the tardy return of the station-to-home user's overnight rental causes the last distribution-user deployed from the central home-station to be without a vehicle. In this situation the late charge may or may not be charged to the station-to-home user depending upon whether the late vehicle return results in a distribution-user not having a vehicle to go to his day-station.

Alternatively, in this scenario the shared vehicle rental system may expect the station-to-home user's vehicle to be returned by 8:00 AM and the system may recognize that the station-to-home user's vehicle has not been returned on time. If there is an unscheduled rental request at the central home-station for a vehicle that will soon be needed by a distribution-user, the shared vehicle rental system may inform the unscheduled user that all vehicles at the central home-station are currently needed to support day-station distribution-users, e.g., by illuminating a “reserved” light near each vehicle that is reserved for distribution-users. This proactive method of managing the allocation of the system's resources to scheduled commitments helps minimize the number of inconvenienced scheduled users due to late returning shared vehicles. It may be common for this type of resource availability denial to occur at day-stations near the end of the workday since the shared vehicles would be reserved for distribution-users to bring these shared vehicles back to the central home-station for the evening and the rental system may not want to take the risk that the unscheduled user might not return the shared vehicle on time. Denial of service to an unscheduled customer may be considered a last resort (and an indication that more vehicles might be needed at a given station). However, if denying the unscheduled rental avoids inconveniencing a scheduled customer, then the denial of the unscheduled customer should be done to instill a sense of confidence in the system's ability to uphold scheduled rental arrangements.

The past record of each user may also be considered when determining whether or not to allow a short-term, unscheduled rental near a peak demand time. For users that have a tendency to return vehicles late, the system may inform them that there are no vehicles available for rent, while a reliable user who returns vehicles on time may be allowed a short term rental of a vehicle in the middle of a peak period.

A day-station may have a number of vehicles available for rent, but only for a limited time because all the vehicles at the day-station are needed to transport distribution-users back to the central home-station at the end of the work day. This situation may pose a unique communication challenge to potential vehicle users that may be seeking information about the availability of the vehicles at a day station.

In one implementation, an alphanumeric sign may be displayed on top of the day-station to indicate when a potential user would need to return the vehicle to the day-station. The sign may state, for example, “3 Vehicle's Available Until: 5:15”. As a matter of convenience the sign display may alternate with the current time of day, e.g., “Time of Day: 2:24 PM” providing the surrounding area with a clock and drawing the general public's attention to the shared vehicle rental system. The time of day information may also provide a potential user with information regarding how long the vehicle can be rented without having to access the kiosk call for reservation information. Additionally, the electronic sign may also advertise unique opportunities to ride a shared vehicle to another station at a free or reduced rate to aid in the task of balancing the system, e.g., “Free ride to train station”.

The sign may be an electrically controlled display capable of being read in all light conditions. With this type of sign it is easy for a potential vehicle user to determine whether vehicle availability matched the user's mobility needs while walking within view of the day-station. The rental return time would change in real time due to vehicle rental and return activity at the day-station. The day station computer may have the ability to change the latest return time as the inventor of the day-station's shared vehicle changes. If it is not possible to rent a shared vehicle from the day-station due to an absence of shared vehicles at the day-station or the lack of shared vehicles ready to be rented (e.g., because of reservations or charging requirements) the display may show the current time of day or the display could be turned off. Additionally, advertising revenue may be generated from the sign during the evening hours when the day-station is not in operation.

Note that an alphanumeric sign is not necessarily needed at each day-station. More simply, a posted rental return policy may state that all day-station vehicles must be returned by 4:00 PM to ensure shared vehicle availability for returning distribution-users. This limitation could also be implemented in the Round Trip by Time X rental where the latest “Time X” possible would be at 4:00 PM. A disadvantage to not implementing an easily read, alphanumeric sign would be that the user would not know whether there is a vehicle available for rent. Without an easily read from afar alphanumeric sign, the user may be required to approach the day-station and review the displays on each vehicle where the latest return time possible could be displayed. Additionally, the receptacle where the vehicle is directly secured at the day-station could show the latest return time available at the day-station. The receptacles display may be angled outward allowing for easier viewing from afar. This display may be a backlit LCD or LED display.

In general the day station implementation presents a challenge regarding how to display vehicle availability at a rental station. A simple “unavailable” or “available” indication system may not be effective at indicating from a distance to which vehicles are available for rent. Near the peak rental periods where distribution-users place a high demand on the system resources, it is difficult to display whether vehicles are available for an unscheduled rental with a single “available” indicator. Having a large time based display showing the latest required vehicle return time possible may provide users with the information needed to determine whether their local mobility need aligns with the shared vehicle rental system's unscheduled rental availability. This is due to the fact that once a vehicle is at a day station it is no longer “available” but rather it is “available until time X”.

In the day station model, “Time X” is based upon when each distribution-user is scheduled to return home. In the Round Trip by Time X model (nested rentals), “Time X” is based upon when the next user needs to take the vehicle back to the day station where the user initiated their round trip rental. Additionally if Internet-based, SMS, telephone, or any other form of reservation is supported by the day station rental system, it may be useful to have some method of indicating that a vehicle is available to meet a reservation commitment but not available to initiate a round trip rental. To address the problem of indicating whether a vehicle is “available” or not, a vehicle may be shown as currently reserved, e.g., to meet obligations associated with distribution-users needing to complete their round trip rental after leaving their vehicle at the day station for some period of time or to meet a reservation need. A “reserved” light may indicate that a vehicle is not readily available to start out a round trip rental, however, a vehicle attached to a security device with an illuminated “reservation” indicator light could alert a user that the vehicle is available to satisfy a previous commitment. An illuminated “unavailable” light may indicate that the system is working but that the vehicle is not available due to battery charging or technical problems. An illuminated “available” light may indicate that a vehicle is available to initiate a round trip rental with a time limitation if any being displayed on the vehicle display.

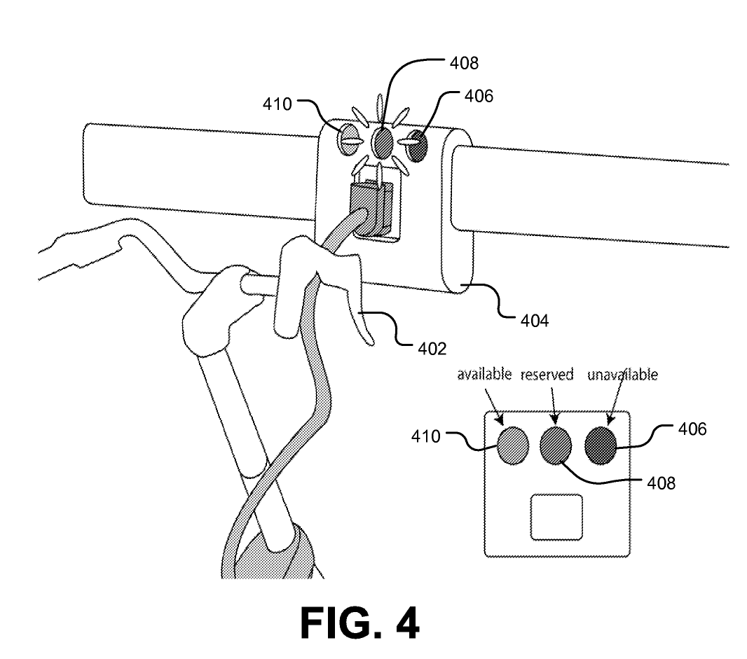

As shown in FIG. 4, a shared vehicle 402 attached to a charge port 404 can be in three different states: charging, reserved, and available. It may be appropriate to use three distinctly different indicators on each charge port 404. Each indicator could display a different state of the shared vehicle 402 attached to the charge port 404. The following indicator definitions serve as one of many possible ways of easily indicating the state of shared vehicles 402 attached to the charge port 404.

1) A charging LED 406 is activated to indicate the shared vehicle needs to be charged by the charge port and is currently not available.

2) A reserved LED 408 is activated to indicate the shared vehicle is not available to initiate a new rental but is available for reservations (i.e., the vehicle is being held to assure system reservations can be met at this station).

3) An available LED 410 is activated to indicate the shared vehicle is available for rental until the time shown on the vehicle's display.

Another exemplary method for determining when a day-station user is able to rent a vehicle is described below. In this example, a computer system (either stand-alone or Internet connected) may be used to manage a day-station in a user-distributed shared vehicle system. When there are multiple vehicles at a day-station, the shared vehicle rental system can be somewhat flexible when determining the time of day that a day-user can return a vehicle. Imagine there are 5 vehicles at a day station with the vehicle distribution-users intending to return to the central home-station at 5:00 PM, 5:10 PM, 5:20 PM, 5:30 PM and 6:00 PM. Assuming there is no 4:00 PM limitation on day-station rental initiations, this arrangement allows day-users to rent available shared vehicles as long as the shared vehicles are returned early enough for each shared vehicle to be ready for the reserved rental. For shared vehicles not needing electric battery charging, a 10-minute time period between rentals may be sufficient. For electric vehicles with a quick battery charging system, 30 minutes of charging could be sufficient to charge the shared vehicle before the distribution-user takes the shared vehicle back to its central home-station.

The following examples assume the shared vehicle's in the rental system are electric, but the basic system works the same with non-electric vehicles where the time between rentals could be reduced from a 30 minute fast battery recharge time to 10 minutes or less. An exemplary list maintained within the computer managing the shared vehicle rental system may appear as in the table below. The first shared vehicle rented from the day-station may have a return time as late as 5:30 PM leaving 30 minutes for the first shared vehicle's batteries to be sufficiently recharged for the distribution-user to return to the first shared vehicle's central home-station. If a day-station user requested to rent a shared vehicle and return it at 5:30 PM the system would allow that rental. If a second person then attempted to rent a shared vehicle until 5:30 PM, it would not be allowed; the second user would have to agree to return his shared vehicle by 5:00 PM to allow for vehicle charging.

TABLE A

| | | Latest Possible |
|---|---|---|
| Scheduled User | Needed | Return Time |
| Distribution-User 1 | 5:00 PM | 4:30 PM |
| Distribution-User 2 | 5:10 PM | 4:40 PM |
| Distribution-User 3 | 5:20 PM | 4:50 PM |
| Distribution-User 4 | 5:30 PM | 5:00 PM |
| Distribution-User 5 | 6:00 PM | 5:30 PM |

Preservation of the shared vehicle/distribution-user relationship simplifies the shared vehicle rental system's software, but may not be practical to implement in the field. It should not be necessary for a distribution-user to remember which shared vehicle was used to ride to the day-station in the morning and attempt to use the same shared vehicle for the return leg of the commute. A more realistic approach to managing the day-station's vehicles is to allow the distribution user to choose any available shared vehicle for the return leg of the commute. The management function of the rental system would then be to ensure that a sufficient number of vehicles be present at the station when needed for each distribution-user's return leg of the commute.

The following discussion concerns an example algorithm to manage an automated shared vehicle day station. Short charging times using rapid battery charging technology is commercially available for NiCd, NiMH and Lilon battery technologies which are quite common in contemporary electric vehicles. It is feasible to implement an electric vehicle charging station at the day-station to deliver an 80% battery state of charge to a fully depleted vehicle battery in 30 minutes. It may be assumed that the last leg of the distribution-user's rental will be more direct and a shorter distance than other day station rentals enabling an 80% battery state of charge to deliver distribution-users to central home-station reliably. Implementing rapid battery charging technology at the day-station allows shared electric vehicle batteries to be a minimum of 80% charged when the distribution-user leaves the day station after a 30-minute recharge time just before the journey.

It is not a requirement of a day-station or any user-distributed shared vehicle system to utilize rapid battery charging technology to operate, but it is helpful to conceptualize how a day-station system or any user-distributed shared vehicle system could function when a quick, fixed, vehicle battery recharge time is included in a system operations schedule. Note that the day-station concept can be applied to non-electric but fuel-based vehicles where the refueling can be performed by vehicle users or system managers. However, for this description we will assume a 30 minute fast charged battery systems on electric vehicles.

One method of implementing the day-station rental system operation is to follow a few basic rules. When these rules are followed by the day-station's computer, the system may operate autonomously. Shared vehicles that are charged the most are the first to be made available for rent. Additionally these rules assure the shared vehicles needed to satisfy future reservations are in the charge port as little time as possible before being allocated to meet reservation commitments.

Rule 1: When a shared vehicle is returned to a station, the system should determine if it is possible for the newly returned vehicle to satisfy a pending reservation. If possible, the newly returned vehicle may be assigned to a pending reservation allowing the vehicle that has been in at the charge station longer to become available for walk up rental (if sufficiently charged). If not sufficiently charged, the vehicle that has been in the charge port longer should be more charged than the newly returned vehicle so the vehicle that has been at the charge port longer should become available for rent sooner than the newly returned vehicle.

Rule 2: When a charge port detects that a shared vehicle has reached a sufficiently charged battery state to be rented, the system should evaluate whether a less charged vehicle attached to the station could meet a reservation commitment for the newly charged vehicles. If a less charged vehicle can meet the newly charged vehicle's reservation commitment, the less charged vehicle should be assigned the reservation commitment and the newly charged vehicle should be made available for rent.

When a shared vehicle is returned to a station, the electric vehicle rental system may determine if it is possible for the newly returned vehicle to satisfy a pending reservation. If possible, the newly returned vehicle may be assigned to the earliest pending reservation possible. If another vehicle was previously assigned the pending reservation, that other vehicle may then be made available to satisfy another pending reservation, or if no other pending reservations can be satisfied, the vehicle that is no longer satisfying a reservation may be made available for rent (if sufficiently charged). If not sufficiently charged, the vehicle that is no longer satisfying a reservation is likely more charged than the newly returned vehicle so the vehicle that has been at the charge port longer should become available for rent sooner than the newly returned vehicle.

By following Rule 1 every time a vehicle is returned to a station, there is an opportunity to shuffle the day-station's resources to ensure that the shared vehicles present in the station are available to meet future reservations. By following Rule 2 every time a charge port detects that a shared vehicle has become sufficiently charged to rent, there will be an additional opportunity to shuffle the day-station's resources. Rule 2 tends to realign any assumptions that may be untrue regarding vehicle state of charge based upon how long each shared vehicle has been attached to a charge port. By having these rules based upon detectable changes in the day-station's status, it simplifies the day-station vehicle rental system's vehicle management algorithm sufficiently to enable straight-forward programming practices to be applied to the task.

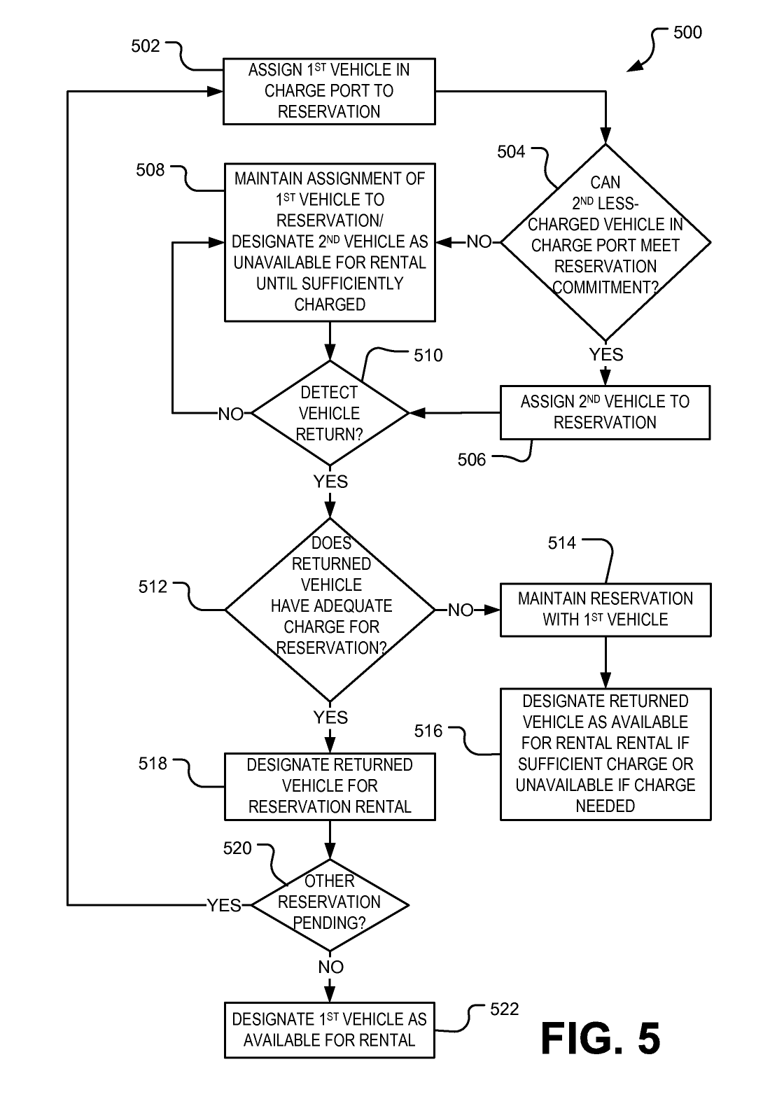

FIG. 5 depicts an exemplary embodiment of a process 500 or algorithm implementing the above rules that may be used as part of a software application managing the user-distributed shared vehicle system using battery powered electric vehicles. It should be understood that these same principles may be applied to other shared vehicle fleets, e.g., vehicles requiring refueling. In a first assignment operation 502, a first vehicle in a station charge port is detected and allocation of a user reservation is assigned. This reservation may be, for example, a reservation from a distribution user to return to a central home-station from a day-station near the distribution user's workplace as part of his return commute. The process 500 next conducts a query 504 to determine whether a second vehicle also docked in a station charge port, but with less charge than the first vehicle, has enough stored energy to meet the reservation commitment previously assigned to the first vehicle. If it is determined that the second vehicle is adequately charged to meet the reservation commitment, the reservation is reassigned to the second vehicle in a second assignment operation 506. If the second vehicle does not have adequate charge reserve, then the reservation will be maintained with the first vehicle in maintaining operation 508. Additionally, since the second vehicle is unable to fulfill the reservation requirement, the second vehicle may remain locked and unavailable for rental or allocation to a reservation until sufficiently charged to meet such demands as is also indicated in maintaining operation 508.

The process 500 next determines whether or not any vehicles have been returned regardless of whether the reservation was maintained with the first vehicle or reassigned to the second vehicle. If no vehicle return is detected as indicated in detection operation 510, the process 500 may maintain the reservation with the first vehicle, but continue to periodically check for newly returned vehicles to further determine whether to reallocate vehicle resources. If a vehicle return is detected in detecting operation 510, then the method further queries whether the returned vehicle has adequate charge remaining to fulfill the reservation presently assigned to the first vehicle as indicated in query operation 512. If the returned vehicle does not have adequate energy reserves to fulfill the reservation assigned to the first vehicle, the reservation is maintained with the first vehicle in maintaining operation 514. Further, the returned vehicle is designated as either available for rental if there is sufficient charge to meet a short rental period request or as unavailable if additional charging is needed before the returned vehicle can be released for a walk-up rental as indicated in designating operation 516.

Alternately, if the returned vehicle is found to have sufficient charge to handle the reservation previously assigned to the first vehicle, then the reservation will be reassigned and the returned vehicle will be designated as reserved and unavailable for walk-up rental as indicated in designating operation 518. At this point, the first vehicle is no longer in a reserved status. The process 500 further checks to see whether any other reservations are pending and in need of assignment to a vehicle as indicated in query operation 520. If there are no other reservations pending, then the first vehicle will be designated as available for walk-up rental as indicated in designation operation 522. Alternatively, if there is another pending reservation, the first vehicle will be assigned the reservation as indicated in assigning operation 502 and the process 500 will continue to loop through the operations described above to continually balance the load on the system and most efficiently allocate vehicle resources to meet changing needs.

Below are a number of examples of how Rules 1 & 2 and the process of FIG. 5 can be applied to some simple day station situations. For the sake of these examples a green LED indicates the shared vehicle is available to initiate a round trip rental, a red LED indicates the shared vehicle is not available for rental and a yellow LED indicates the shared vehicle is available to satisfy a reservation or allow a distribution-user to complete a leg of a commute.

TABLE B

| Return Leg | Rental | | |
|---|---|---|---|
| Reservation | Return | | |
| Time | Time | Status | Upon Return |
| 5:00 | 4:30 | Rented | Red LED until 4:00, then green LED |
| | | until | is lit for 30 minutes, then Yellow |
| | | 3:30 | LED is lit. The rental period |
| | | | between 4:00 and 4:30 would be |
| | | | allowed by the day station only if |
| | | | the user agreed to return the |
| | | | shared vehicle by 4:30. |
| 5:00 | 4:30 | Rented | Red LED until 4:45 when yellow LED |
| | | until | is lit (extra 15 minutes of |
| | | 4:15 | charging) |
| 5:00 | 4:30 | Rented | Red LED until 5:00 when yellow LED |
| | | until | (just ½ hour of charging) |
| | | 4:30 | |

If the user was not willing to commit to that return time, then the shared vehicle would not be released from the charge receptacle. If the user committed to returning the vehicle by 4:30, but was not timely upon his return, the shared vehicle's rental accessory pack could communicate to the user that the shared vehicle needs to be returned by 4:30 or an additional fine will be implemented. The shared vehicle's rental accessory pack could also beep and/or flash to gain the user's attention regarding the passed rental return time. In the above day-station status chart, there are three distribution-users that intend to use a shared vehicle to travel from the day-station to the central home-station starting at 5:00. Note that to have these shared vehicles 80% charged at 5:00, the vehicles would need to be returned by 4:30 to allow for 30 minutes to fast charge. The Last Rental Return time for this exemplary day-station is 4:30. If a day-station user return his vehicle after the Last Rental Return time, it is likely that a distribution-user relying upon the vehicle being available at the day-station would be inconvenienced by the lack of a sufficiently charged vehicle.

When a user wants to rent a shared vehicle for a round trip rental the user can walk up to any vehicle attached to a charge receptacle with an illuminated green LED and look at the vehicle's rental accessory pack display where the Latest Rental Return time may be shown. The Latest Rental Return time is of interest to the user as it is the latest time of day that the potential user can return a vehicle rented from this day-station with out incurring a late fee. The Latest Rental Return time may change due to vehicles being returned and vehicles becoming charged. By displaying the Latest Rental Return time during the initial rental transaction and continuing to display the Latest Rental Return time, (or the number of minutes left before the Latest Rental Return time) on the vehicle's rental accessory pack the user is constantly informed as to the required vehicle return time.

Three different scenarios (unrelated to one another) each show how the Latest Rental Return may be calculated according to different implementations.

TABLE C
Scenario 1

| Return Leg | Rental | | |
|---|---|---|---|
| Reservation | Return | | |
| Time | Time | Status | Upon Return |
| 3:00 | 2:30 | Available | Green LED (unless rented) until |
| | | until | 2:30, then Yellow LED is lit |
| | | 2:30 | |
| 4:00 | 3:30 | Rented | Once returned Red LED until |
| | | until | 3:30, then Yellow LED is lit |
| | | 3:00 | |
| 5:00 | 4:30 | Rented | Once returned Red LED until |
| | | until | 5:00, then Yellow LED is lit |
| | | 4:30 | |

| | |
|---|---|
| Latest Rental Return: | 2:30 |

TABLE D
Scenario 2

| Return Leg | Rental | | |
|---|---|---|---|
| Reservation | Return | | |
| Time | Time | Status | Upon Return |
| 3:00 | 2:30 | Returned | Red LED until 2:30, then |
| | | at 2:00 | yellow LED is lit |
| 4:00 | 3:30 | Available | Green LED (unless rented) |
| | | until | until 3:30, then Yellow LED |
| | | 3:30 | is lit |
| 5:00 | 4:30 | Rented | Once returned Red LED until |
| | | until | 5:00, then Yellow LED is lit |
| | | 4:30 | |

| | |
|---|---|
| Latest Rental Return: | 3:30 |

TABLE E
Scenario 3

| Return Leg | Rental | | |
|---|---|---|---|
| Reservation | Return | | |
| Time | Time | Status | Upon Return |
| 3:00 | 2:30 | Rented | Once returned Red LED until |
| | | until | 2:30, then Yellow LED is lit |
| | | 2:00 | |
| 4:00 | 3:30 | Rented | Once returned Red LED until |
| | | until | 2:30, then Green LED is lit |
| | | 2:00 | until rented (1 hr rental max) |
| 5:00 | 4:30 | Available | Green LED (unless rented) |
| | | until | until 4:30, then yellow LED |
| | | 4:30 | is lit |

| | |
|---|---|
| Latest Rental Return: | 4:30 |

In the above day-station status charts, if a day-station user wants to rent a vehicle that is plugged into a charge port with an illuminated Green LED, the user would have to agree to a rental return time no later than the Last Rental Return time to be issued the vehicle.

Below are several day-station status charts showing different situations that are related to one another in a timed sequence.

TABLE F
Day station status at 2:00

| Return Leg | Rental | | | |
|---|---|---|---|---|
| Reservation | Return | | | |
| Time | Time | Vehicle | Status | Upon Return |
| 3:00 | 2:30 | A | Available | Green LED (unless |
| | | | until | rented) until 2:30 then |
| | | | 2:30 | Yellow LED is lit |
| 4:00 | 3:30 | B | Rented | Once returned Red LED |
| | | | until | until 3:30 then Yellow |
| | | | 3:00 | LED is lit (charging |
| | | | | ½ hr extra) |
| 5:00 | 4:30 | C | Rented | Once returned Red LED |
| | | | until | until 5:00 then Yellow |
| | | | 4:30 | LED is lit |

| | |
|---|---|
| Latest Rental Return: | 2:30 |

Table F depicts the status of three shared vehicles A, B, and C based at the same day-station. Vehicle A is docked and available for rental as indicated by the green LED until half an hour before a distribution-user is schedule to return Vehicle A to a central home-station. Vehicle B is rented and out of the station until 3:00 at which time it will be charged. Vehicle C is also rented and out of the station until 4:30 at which time it will be charged and unavailable.

TABLE G
Day station status after 2:15

| Return Leg | Rental | | | |
|---|---|---|---|---|
| Reservation | Return | | | |
| Time | Time | Vehicle | Status | Upon Return |
| 3:00 | 2:30 | B | Returned | Returned! Red LED lit |
| | | | at 2:15 | until 2:45 then Yellow |
| | | | | LED is lit |
| 4:00 | 3:30 | A | Available | Green LED (unless |
| | | | until | rented) until 3:30 then |
| | | | 3:30 | yellow LED is lit |
| 5:00 | 4:30 | C | Rented | Once returned Red LED |
| | | | until | until 5:00 then yellow |
| | | | 4:30 | LED is lit |

| | |
|---|---|
| Latest Rental Return: | 3:30 |

As shown in Table G, an early Return at 2:15 of vehicle B makes it possible to satisfy the 3:00 reservation with the newly returned vehicle B while making vehicle A available for walk-up rental until 3:30 (following Rule 1). Note Vehicle A and B swapped in status in Table G when compared to Table F.

As soon as the 2:15 rental return of vehicle B arrives, the Latest Rental Return time can be increased from 2:30 to 3:30 and vehicle A that was slated to fill the 3:00 Return Leg Reservation can be rented until 3:30. This is because vehicle B returned at 2:15 will be sufficiently charged by the 3:00 distribution-user deploy time. The system will have more rental time available by committing the most recently received vehicle to the earliest reservation.

TABLE H
Day station status after 3:15 - Scenario 1

| Return Leg | Rental | | | |
|---|---|---|---|---|
| Reservation | Return | | | |
| Time | Time | | Status | Upon Return |
| 3:00 | 2:30 | B | Dispatched with | |
| | | | Distribution | |
| | | | user at 2:37 | |
| 4:00 | 3:30 | A | Available | Green LED (unless |
| | | | until | rented) until |
| | | | 3:30 | 3:30 then yellow |
| | | | | LED is lit |
| 5:00 | 4:30 | C | Returned | Once returned Red |
| | | | at 3:15 | LED until 3:45 |
| | | | | then green LED |
| | | | | until 4:30 |
| | | | | (unless rented) |

| | |
|---|---|
| Latest Rental Return: | 3:30 |

Table H shows a second scenario when vehicle C is returned at 3:15 rather than at 4:30 and Rule 1 is not applied. In Table H, Vehicle A would be rentable for 15 minutes before needing to be returned at 3:30. Then at 3:45 Vehicle C would be rentable for 45 minutes before needing to be returned at 4:30. This fragmented distribution of rental time could be considered less desirable to a potential user than having one vehicle available for a longer period of time.

Notice that Vehicle C has arrived early enough to be fully charged by 4:00 making Vehicle C able to fulfill the 4:00 distribution-user's return leg reservation. If Vehicle C is allocated to fulfill the system's 4:00 reservation, Vehicle A may be made available until 4:30 increasing the rental time of Vehicle A, which could be considered more valuable than a 15 minute rental and a 45 minute rental later in the day. If instead Rule 1 is followed, the day-station status in Table H would look more like Table I below.

TABLE I
Day station status after 3:15 - Scenario 2

| Return Leg | Rental | | | |
|---|---|---|---|---|
| Reservation | Return | | | |
| Time | Time | Vehicle | Status | Upon Return |
| 3:00 | 2:30 | B | Dispatched with | |
| | | | distribution- | |
| | | | user at 2:37 | |
| | | | (now at central- | |
| | | | home-station) | |
| 4:00 | 3:30 | C | Returned | Once returned Red |
| | | | at 3:15 | LED until 3:45 |
| | | | | then yellow LED |
| | | | | is lit |
| 5:00 | 4:30 | A | Available | Green LED (unless |
| | | | until | rented) until |
| | | | 4:30 | 4:30 then yellow |
| | | | | LED is lit |

| | |
|---|---|
| Latest Rental Return: | 4:30 |

By matching the vehicle to an appropriate reservation (Applying Rule 1) it is possible to extend the Latest Rental Return and have a single vehicle available for rent over a longer period of time. In application this method of assigning an appropriate vehicle to a reservation would not be disruptive to users of the day station as it would extend the continuous time that vehicle A would be available for rent (3:30 to 4:30) while the newly returned Vehicle C status light would be a Red LED (i.e., charging and unavailable) for the first half hour in either situation. Note that moving vehicles in these day-station status charts merely changes which vehicle is slated to satisfy a particular reservation; the vehicle is not physically moved in the day-station.

Since the day-station distribution-user's return leg departure times are known and the maximum time needed for a shared vehicle to obtain an 80% charge is known, it is relatively easy to determine when a vehicle needs to be returned to the charge port. Each reservation's Rental Return Time is actually a cut-off time where the system needs to secure sufficient resources to meet future reservations. If there are insufficient shared vehicles to satisfy the upcoming reservations, the system will know about it 30 minutes before the reservation is missed (or whatever the battery charge time is determined to be to provide sufficient charge for the distribution-user to complete the last leg of the journey). The system can use that time to begin to plan for the missed reservation by either re-evaluating the day-station's shared vehicle distribution to determine if other shared vehicles will be available that could satisfy the upcoming reservation or by making alternative transportation arrangements for the user (e.g., alerting a cab of a potential need of a ride or alerting the system manager to request an additional vehicle be delivered to the day station). By having a concrete cut-off time to meet reservation commitments, it becomes possible to use straight-forward software algorithms to satisfy existing reservations. It also provides an easy method of determining when to commit vehicles to a particular reservation.

If a user schedules to return before the Latest Rental Return, the system can include this information in the operational schedule which can make a fully charged vehicle in the station available for rent if there is time to charge newly returned vehicle to satisfy future reservations (such as a distribution-user's need to return to the central home-station). For greatest efficiency in use of the vehicles at the day-station, it is important to assign a shared vehicle to the earliest commitment that a shared vehicle can satisfy. This also keeps the earlier commitments satisfied before the later commitments. If there are no commitments that can be satisfied by the returned vehicle, then it may be rented after being sufficiently charged. Commitments should be satisfied at the latest moment possible (e.g., a shared vehicle should not be committed at 10:00 AM for a 3:00 PM reservation).

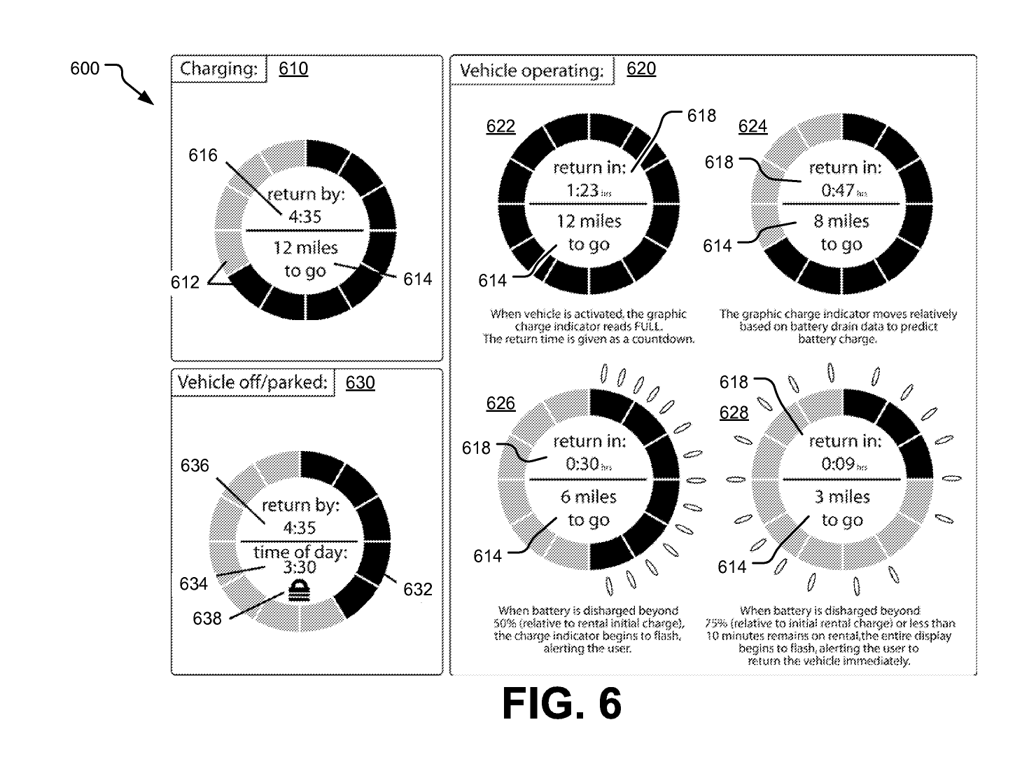

A shared electric vehicle day-station implementation may include a vehicle-mounted interface with a display that provides the user with information regarding conditions relating to the vehicle rental as depicted, for example, in FIG. 6. Several features of the display may aid a potential vehicle user when interacting with a day-station electric vehicle rental system. When the vehicle is plugged in, the vehicle display 610 or charge receptacle display can show the potential user the predicted state of charge 612 of the vehicle. The state of charge 612 of the vehicle battery may be shown by a bar graph surrounding the outer perimeter of the display making the bar graph as big as possible for a given display size to increase visibility of the bar graph from a distance away. This easily seen feature of the display allows the potential user to select a shared vehicle based upon its state of charge 612 in comparison to other available shared vehicles at the rental station that have their state of charge 612 also shown on their own displays. A potential shared vehicle user that is planning a long rental with a significant distance to travel could use the bar graph state of charge display 612 to quickly compare the state of charge of all the available vehicles.

The number of miles in a reliable range of operation 614 or the number of minutes of reliable operation (not shown) with the current battery state of charge may also be shown on the vehicle display 610 as shown in FIG. 6 while the vehicle is attached to the charge receptacle. Additionally the vehicle display may show a potential user the time of day when the vehicle needs to be returned 616. By showing the potential vehicle user when the vehicle needs to be returned, 616 the vehicle display 610 provides information about how long the vehicle can be away from the day station before needing to be returned. The potential vehicle user may use this information to determine the best vehicle to meet the user's mobility needs and be further advised as to the required return time in order to preserve the balance of the day station's rental system. The data shown on the vehicle display 610 may be provided to the vehicle display 610 from the station computer system via a wired or wireless link and may be saved to memory in the vehicle's embedded microprocessor.

Once a user successfully rents a vehicle from the day station for a round trip rental, the vehicle display 620 may change modes to provide the vehicle's operational data in a more useful format to the user during their vehicle rental period. For example, the bar graph indicating the vehicle's state of charge may change from the absolute state of charge meter displayed before the rental, where the number of bar graph segments illuminated is proportional to the percentage of the vehicle's entire battery charge, to a relative state of charge meter 622 where all the segments are illuminated indicating that immediately after renting the vehicle the remaining battery state of charge is shown as 100% of the remaining battery capacity. With the relative battery state of charge bar graph display 622 there is no need for the user to remember the number of bar graph segments that were illuminated when the vehicle was first rented and then calculate what the remaining number of segments would be to deplete the vehicle's battery bank by a given percentage because immediately after the rental is initiated all the segments of the state of charge bar graph are illuminated to indicate that 100% of the remaining battery state of charge is available to the current user. Additionally by using the entire number of bar graph segments to show the user how much battery capacity is available through the rental the vehicle's state of charge bar graph meter's resolution is effectively increased making it possible for the user to more accurately determine how close the user is to depleting the vehicle's battery a given percentage during the rental.

By switching from an absolute to a relative battery state of charge meter upon vehicle rental, it is easy for the user to determine how much longer the vehicle will operate based upon the vehicle bar graph display 624 showing the amount of energy consumed during the user's rental in relation to the amount of energy stored in the vehicle's battery when the rental was initiated. Since a relative vehicle battery state of charge meter does not give the user any indication of the amount of time or distance the vehicle can operate, it may be helpful for the user to see the predicted range or predicted operation time for the amount of charge remaining in the battery. The vehicle display may show the user the number of miles or kilometers of predicted range 614 as before rental or the number of minutes the vehicle is predicted to operate 618. The relative battery state of charge meter 626 indicates when the user has consumed half of the stored battery energy available for the entire rental period, by showing half of the bar graph segments being illuminated. This combination of display information available to the user during the electric vehicle rental allows the user to easily and intuitively interpret the bar graph data and the length of predicted operation. This aids the user in avoiding a situation where the vehicle's battery becomes entirely depleted stranding the user because of attempting to get the vehicle to go too far on a given amount of battery charge as shown in the display of the relative battery state of charge meter 628.

The state of charge 622, 624, 626, 628 and predicted range 614 or predicted operation time 618 shown on the vehicle display 620 may be reduced based upon how the user chooses to operate the vehicle. By monitoring the intensity of vehicle usage based upon vehicle battery drain measurements or accelerometer measurements, it is possible for the vehicle's embedded microprocessor to periodically recalculate the state of charge 622, 624, 626, 628 and predicted range 614 or predicted operation time 618 of the vehicle. With this type of onboard vehicle monitoring/processing the state of charge 622, 624, 626, 628 and predicted range 614 or predicted operation time 618 may be shown as reduced if the user rides the vehicle quite aggressively. Similarly, the displayed vehicle battery state of charge 622, 624, 626, 628 and predicted range 614 or predicted operation time 618 may be increased if the user chooses to ride conservatively. This level of vehicle operation feedback may be useful to the user when determining how to extend a vehicle's range or operation time.

Alternatively rather than taking away a block of operational minutes all at once, e.g., due to a three minute period of aggressive vehicle handling, it may be appropriate to deduct one minute of operation time for every thirty seconds of aggressive vehicle handling. This would be less disturbing to the user as the user would not see the predicted operation time reduced from ten minutes to four minutes instantly, but for every thirty seconds of aggressive riding the vehicle display may indicate a deduction, for example, of one minute off the predicted vehicle operational time.

It may also be useful to the user during the rental period for the vehicle display 630 to depict the amount of rental time remaining as a countdown timer 618 rather than as an absolute return time of day 616, 636. This display feature eliminates the need for the user to calculate a use period or to know the time of day for return of the vehicle. A quick glance at the vehicle display will indicate how many hours and minutes can pass before the vehicle needs to return to the day station in order to meet future scheduled reservations, keep the system in balance, and enable the user to avoid late vehicle return charges. Although discussed here in the context of electric vehicle, a vehicle display indicating the relative time remaining before a shared vehicle needs to be returned to its day station may also be used for non-electric vehicles with electric displays (e.g., battery or kinetically powered). This allows a non-electric shared vehicle system to efficiently operate in a day station configuration as well.

In a well-balanced system, vehicles are available to meet reservation commitments such as distribution-users needing to use a vehicle on the return leg of a commuting journey. Additionally, day stations may also manage vehicles by holding the correct number of vehicles to meet all reservations actively made by users through the Internet via a website portal, SMS reservation, or other method of making reservations. By showing the amount of time left in the rental as in FIG. 6 the shared vehicle user is continually reminded that the vehicle needs to be returned by a particular time. As that time approaches, the display 628 may begin to flash, generate sounds, or provide other notifiers as the return time approaches or becomes past due making it more obvious that the user needs to return the shared vehicle to the day station where the vehicle was initially rented.

When a day station vehicle is turned off and parked in a location other than a day station, the vehicle display 630 may show the user the current time of day 634 and the return time 636. The bar graph 632 may display the relative state of charge without further definition of the overall predicted range or operation time. It may be useful to provide less information about the vehicle's absolute state of charge to thwart a potential vehicle thief who may see the vehicle with the highest battery charge as the most desirable vehicle to steal. Additionally, a lock icon 638 may be displayed to show the user that the vehicle security cable is currently locked. The locking mechanism may also be disengaged for a given period of time every time the vehicle is turned off. When the vehicle lock is disengaged, the user can disconnect one end of the security cable from its normally locked position on the vehicle and allow the security cable to be routed around a strong stationary object. Once the end of the security cable is replaced into the locked position, the lock icon 638 on the vehicle display 630 may indicate that the vehicle's security cable latch is locked.

By providing easily interpreted information to the user during their vehicle rental, the user will become comfortable about operating within the confines of the day station rental system. A small amount of limitation placed upon the day station user in the form of a scheduled return to the day station brings about a great opportunity in providing distributed shared vehicles that are more readily available and more cost effective when compared to other shared vehicle distribution systems.

An alternative method of managing the resources of an electric vehicle rental system may involve querying the user during the initial rental procedure regarding vehicle use either in distance traveled, time rented, or both. The query results may then be used to determine which vehicle in the fleet is best suited to meet the user's stated needs. Vehicles that are fully charged would be assigned to users that plan on riding for long distances. Alternatively, users that planning to use a vehicle for short distances would be assigned vehicles with sufficient battery charge to complete the journey. The user query may be performed at a kiosk located at the day station or at any docked vehicle through the vehicle display and keypad or other interface. Alternately, the usage query could be made from a remote Internet site, e.g., the rental system's website or a third party reservation web site, when vehicle reservations are being made enabling the rental system the ability to assign and reserve the appropriately charged vehicle to meet the users intended needs. Once a suitable vehicle is determined, the rental system then directs the user to the charge port where the assigned vehicle is parked. This method may be used to ensure that the most appropriate vehicle is assigned to meet the user's mobility needs.

This approach may be more appropriate for electric vehicles with short operational range and/or long battery charging times. As the range of the vehicles is increased and the battery charge time is reduced, e.g., through better battery technology and/or faster battery chargers, there is less need to closely manage the system's vehicle battery state of charge. This makes it possible for the electric vehicle rental system to operate effectively with the user having the freedom to select any vehicle that is available for rent.

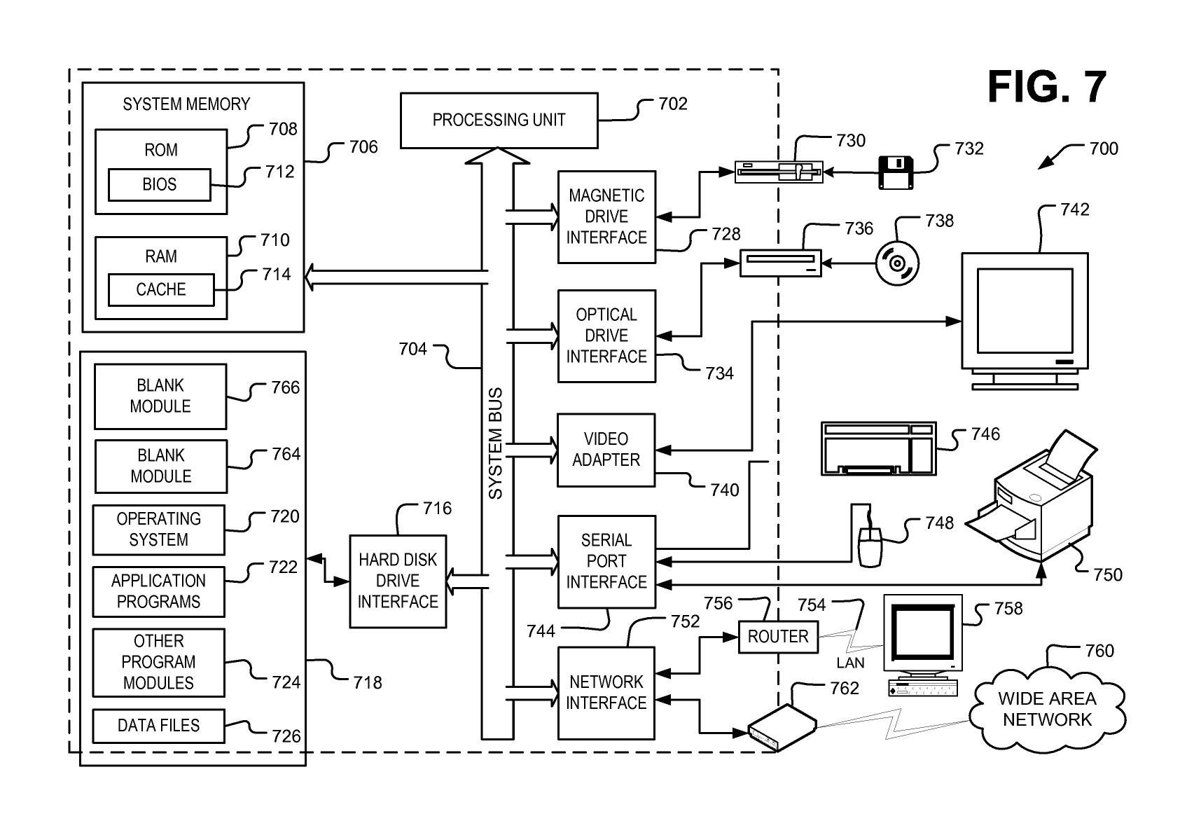

An exemplary computer system 700 for implementing processes performed by the distributed-user shared vehicle system above is depicted in FIG. 7. The computer system 700 of the system management or home-station or day-station kiosk may be a personal computer (PC), a workstation, a notebook or portable computer, a tablet PC, a handheld media player (e.g., an MP3 player), a smart phone device, a video gaming device, or a set top box, with internal processing and memory components as well as interface components for connection with external input, output, storage, network, and other types of peripheral devices. Internal components of the computer system in FIG. 7 are shown within the dashed line and external components are shown outside of the dashed line. Components that may be internal or external are shown straddling the dashed line. Alternatively to a PC, the computer system 700, for example, for running the system, may be in the form of any of a server, a mainframe computer, a distributed computer, an Internet appliance, or other computer devices, or combinations thereof.

In any embodiment or component of the system described herein, the computer system 700 includes a processor 702 and a system memory 706 connected by a system bus 704 that also operatively couples various system components. There may be one or more processors 702, e.g., a single central processing unit (CPU), or a plurality of processing units, commonly referred to as a parallel processing environment (for example, a dual-core, quad-core, or other multi-core processing device). The system bus 704 may be any of several types of bus structures including a memory bus or memory controller, a peripheral bus, a switched-fabric, point-to-point connection, and a local bus using any of a variety of bus architectures. The system memory 706 includes read only memory (ROM) 708 and random access memory (RAM) 710. A basic input/output system (BIOS) 712, containing the basic routines that help to transfer information between elements within the computer system 700, such as during start-up, is stored in ROM 708. A cache 714 may be set aside in RAM 710 to provide a high speed memory store for frequently accessed data.

A hard disk drive interface 716 may be connected with the system bus 704 to provide read and write access to a data storage device, e.g., a hard disk drive 718, for nonvolatile storage of applications, files, and data. A number of program modules and other data may be stored on the hard disk 718, including an operating system 720, one or more application programs 722, and data files 726. In an exemplary implementation, the hard disk drive 718 may store a scheduling and monitoring application 724 for management of the user-distributed shared vehicle system according to the exemplary processes described herein above. Note that the hard disk drive 718 may be either an internal component or an external component of the computer system 700 as indicated by the hard disk drive 718 straddling the dashed line in FIG. 7. In some configurations, there may be both an internal and an external hard disk drive 718.

The computer system 700 may further include a magnetic disk drive 730 for reading from or writing to a removable magnetic disk 732, tape, or other magnetic media. The magnetic disk drive 730 may be connected with the system bus 704 via a magnetic drive interface 728 to provide read and write access to the magnetic disk drive 730 initiated by other components or applications within the computer system 700. The magnetic disk drive 730 and the associated computer-readable media may be used to provide nonvolatile storage of computer-readable instructions, data structures, program modules, and other data for the computer system 700.

The computer system 700 may additionally include an optical disk drive 736 for reading from or writing to a removable optical disk 738 such as a CD ROM or other optical media. The optical disk drive 736 may be connected with the system bus 704 via an optical drive interface 734 to provide read and write access to the optical disk drive 736 initiated by other components or applications within the computer system 700. The optical disk drive 730 and the associated computer-readable optical media may be used to provide nonvolatile storage of computer-readable instructions, data structures, program modules, and other data for the computer system 700.

A display device 742, e.g., a monitor, a television, or a projector, or other type of presentation device may also be connected to the system bus 704 via an interface, such as a video adapter 740 or video card. Similarly, audio devices, for example, external speakers or a microphone (not shown), may be connected to the system bus 704 through an audio card or other audio interface (not shown).

In addition to the monitor 742, the computer system 700 may include other peripheral input and output devices, which are often connected to the processor 702 and memory 706 through the serial port interface 744 that is coupled to the system bus 706. Input and output devices may also or alternately be connected with the system bus 704 by other interfaces, for example, a universal serial bus (USB), an IEEE 1394 interface (“Firewire”), a parallel port, or a game port. A user may enter commands and information into the computer system 700 through various input devices including, for example, a keyboard 746 and pointing device 748, for example, a mouse. Other input devices (not shown) may include, for example, a joystick, a game pad, a tablet, a touch screen device, a satellite dish, a scanner, a facsimile machine, a microphone, a digital camera, and a digital video camera.

Output devices may include a printer 750 and one or more loudspeakers 770 for presenting receipts or other information to a user. Other output devices (not shown) may include, for example, a plotter, a photocopier, a photo printer, a facsimile machine, and a press. In some implementations, several of these input and output devices may be combined into single devices, for example, a printer/scanner/fax/photocopier. It should also be appreciated that other types of computer-readable media and associated drives for storing data, for example, magnetic cassettes or flash memory drives, may be accessed by the computer system 700 via the serial port interface 744 (e.g., USB) or similar port interface.

The computer system 700 may operate in a networked environment using logical connections through a network interface 752 coupled with the system bus 704 to communicate with one or more remote devices. The logical connections depicted in FIG. 7 include a local-area network (LAN) 754 and a wide-area network (WAN) 760. Such networking environments are commonplace in home networks, office networks, enterprise-wide computer networks, and intranets. These logical connections may be achieved by a communication device coupled to or integral with the computer system 700. As depicted in FIG. 7, the LAN 754 may use a router 756 or hub, either wired or wireless, internal or external, to connect with remote devices, e.g., a remote computer 758, similarly connected on the LAN 754. The remote computer 758 may be another personal computer, a server, a client, a peer device, or other common network node, and typically includes many or all of the elements described above relative to the computer system 700.

To connect with a WAN 760, the computer system 700 typically includes a modem 762 for establishing communications over the WAN 760. Typically the WAN 760 may be the Internet. However, in some instances the WAN 760 may be a large private network spread among multiple locations, or a virtual private network (VPN). The modem 762 may be a telephone modem, a high speed modem (e.g., a digital subscriber line (DSL) modem), a cable modem, or similar type of communications device. The modem 762, which may be internal or external, is connected to the system bus 718 via the network interface 752. In alternate embodiments the modem 762 may be connected via the serial port interface 744. It should be appreciated that the network connections shown are exemplary and other means of and communications devices for establishing a network communications link between the computer system and other devices or networks may be used.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for balancing a vehicle resource load in a shared-vehicle system comprising
providing a central home-station;
allocating a number of vehicles to the central home station;
providing a number of day-stations associated with the central home-station with facilities for docking and reenergizing the vehicles;
distributing the vehicles to one or more of the day stations via operation by distribution-users with journeys originating from the central home-station and terminating at the day-stations;
providing the vehicles for limited term use by day-users at the day-stations with a requirement that the vehicles be returned to the day-stations by the end of a respective limited term; and
returning the vehicles to the central home-station upon expiration of the limited term use via operation by the distribution users with journeys originating from the day-stations and terminating at the central home-station.

2. The method of claim 1 further comprising locating the central home-station adjacent a mass transit hub.

3. The method of claim 1 further comprising locating the day-stations adjacent user workplaces at distances from the central-home station within range of the vehicles.

4. The method of claim 1 further comprising penalizing a day-user for failing to return a shared vehicle to a respective day-station before expiration of the respective limited term.

5. The method of claim 4 further comprising relating a penalty imposed pursuant to the penalizing operation to a cost of providing an alternate mode of transportation to a respective distribution-user without a respective shared vehicle to return to the central home-station due to the failure of the day-user to return the respective shared vehicle before expiration of the respective limited term.

6. The method of claim 5 further comprising relating the penalty imposed pursuant to the penalizing operation to a cost of retuning the respective shared vehicle to the central home-station using system management personnel and related resources.

7. The method of claim 1 further comprising penalizing a distribution-user for failing to perform the returning operation.

8. The method of claim 7 further comprising relating a penalty imposed pursuant to the penalizing operation to a cost of retuning a respective shared vehicle to the central home-station using system management personnel and related resources.

9. A user interface for a shared vehicle comprising
a first presentation feature presented when the shared vehicle is charging indicating a first relative level of energy storage of an energy storage device for powering the shared vehicle with respect to a fully energized condition and a fully depleted condition;
a second presentation feature presented when the shared vehicle is in an operating mode indicating a second relative level of energy storage of the energy storage device with respect to an initial present total energy condition representative of total stored energy available for powering the shared vehicle when the shared vehicle is switched to the operating mode and the fully depleted condition, initially presenting the initial present total energy level as a maximum level of the second relative level when the shared vehicle is switched to the operating mode and then presenting a linear proportional representation of present total stored energy available until the vehicle reaches the fully depleted condition corresponding to a minimum level of the second relative level; and
a third presentation feature indicating a range of travel of the shared vehicle based upon the first relative level of energy storage.

10. The user interface of claim 9, wherein the first and second presentation features are depicted as bar graphs.

11. The user interface of claim 9, wherein each of the bar graphs is presented as a circle or disk composed of segments.

12. The user interface of claim 9 further comprising a fourth presentation feature indicating a return time of day when a user of the shared vehicle is to return the shared vehicle to a specific location to satisfy known vehicle reservation commitments.

13. The user interface of claim 9 further comprising a fifth presentation feature presented when the shared vehicle is in an operating mode indicating a countdown return time based upon the first relative level of energy storage.

14. The user interface of claim 9 further comprising a sixth presentation feature indicating an alert to a low level of energy storage based upon the first relative level of energy storage.

15. The user interface of claim 9 further comprising a seventh presentation feature indicating a locked status of the shared vehicle when the shared vehicle is in a parked mode.

16. The user interface of claim 9 further comprising an eighth presentation feature indicating a time of day when the shared vehicle is in a parked mode.

17. A method for allocating vehicle resources in a shared-vehicle system comprising
assigning a first vehicle docked at a station to a reserved status to fulfill a first reservation request;
determining whether a second vehicle with lesser energy reserves than the first vehicle also docked at the station can fulfill the first reservation request; and
reassigning the second vehicle to the reserved status to fulfill the first reservation request and releasing the first vehicle from the reserved status and changing the first vehicle to an available status upon a determination that the second vehicle has sufficient energy reserves to fulfill the first reservation request; or
maintaining the assignment of the first vehicle to the reserved status to fulfill the first reservation request upon a determination that the second vehicle has insufficient energy reserves to fulfill the first reservation request.

18. The method of claim 17 further comprising
designating the second vehicle as available for rental if the second vehicle is not reassigned but is determined to have sufficient energy reserves for accommodating a walk-up rental; or
designating the second vehicle as unavailable for rental if the second vehicle is not reassigned and is determined to have insufficient energy reserves for accommodating a walk-up rental.

19. The method of claim 18 further comprising reenergizing the second vehicle while docked at the station.

20. The method of claim 19, wherein if the second vehicle is designated as unavailable, then the method further comprises locking the second vehicle to the station to prevent removal while reenergizing.

21. The method of claim 17 further comprising
detecting whether a third vehicle has been recently docked at the station;
determining whether the third vehicle has sufficient energy reserves to fulfill the first reservation request; and
designating the third vehicle to the reserved status to fulfill the first reservation request and releasing the first vehicle from the reserved status upon a determination that the third vehicle has sufficient energy reserves to fulfill the first reservation request; or
maintaining the assignment of the first vehicle to the reserved status to fulfill the first reservation request upon a determination that the third vehicle has insufficient energy reserves to fulfill the first reservation request; or
maintaining the assignment of the first vehicle to the available status if the second vehicle has been reassigned to fulfill the first reservation request upon the determination that the third vehicle has insufficient energy reserves to fulfill the first reservation request.

22. The method of claim 21 further comprising
designating the third vehicle as available for rental if the third vehicle is not designated to the reserved status but is determined to have sufficient energy reserves for accommodating a walk-up rental; or
designating the third vehicle as unavailable for rental if the third vehicle is not designated to the reserved status and is determined to have insufficient energy reserves for accommodating a walk-up rental.

23. The method of claim 22 further comprising reenergizing the third vehicle while docked at the station.

24. The method of claim 23, wherein if the second vehicle is designated as unavailable, then the method further comprises locking the third vehicle to the station to prevent removal while reenergizing.

25. The method of claim 21, wherein if the third vehicle is detected as docked at the station and the first vehicle is in the available status, the method further comprises
determining whether a second reservation request is pending; and
assigning the first to a reserved status to fulfill the second reservation request if the second reservation request is pending; or
maintaining the first vehicle in the available status if the second reservation request is not pending.

26. A computer-readable medium storing computer-readable instructions for controlling a computer system to allocate vehicle resources in a shared-vehicle system, wherein the instructions comprise operations to
assign a first vehicle docked at a station to a reserved status to fulfill a first reservation request;
determine whether a second vehicle with lesser energy reserves than the first vehicle also docked at the station can fulfill the first reservation request; and
reassign the second vehicle to the reserved status to fulfill the first reservation request and releasing the first vehicle from the reserved status and changing the first vehicle to an available status upon a determination that the second vehicle has sufficient energy reserves to fulfill the first reservation request; or
maintain the assignment of the first vehicle to the reserved status to fulfill the first reservation request upon a determination that the second vehicle has insufficient energy reserves to fulfill the first reservation request.

27. The computer readable medium of claim 26, wherein the instructions further comprise operations to
designate the second vehicle as available for rental if the second vehicle is not reassigned but is determined to have sufficient energy reserves for accommodating a walk-up rental; or
designate the second vehicle as unavailable for rental if the second vehicle is not reassigned and is determined to have insufficient energy reserves for accommodating a walk-up rental.

28. The computer readable medium of claim 27, wherein the instructions further comprise operations to reenergize the second vehicle while docked at the station.

29. The computer readable medium of claim 28, wherein if the second vehicle is designated as unavailable, then the instructions further comprise operations to lock the second vehicle to the station to prevent removal while reenergizing.

30. The computer readable medium of claim 26, wherein the instructions further comprise operations to
detect whether a third vehicle has been recently docked at the station;
determine whether the third vehicle has sufficient energy reserves to fulfill the first reservation request; and
designate the third vehicle to the reserved status to fulfill the first reservation request and releasing the first vehicle from the reserved status upon a determination that the third vehicle has sufficient energy reserves to fulfill the first reservation request; or
maintain the assignment of the first vehicle to the reserved status to fulfill the first reservation request upon a determination that the third vehicle has insufficient energy reserves to fulfill the first reservation request; or
maintain the assignment of the first vehicle to the available status if the second vehicle has been reassigned to fulfill the first reservation request upon the determination that the third vehicle has insufficient energy reserves to fulfill the first reservation request.

31. The computer readable medium of claim 30, wherein the instructions further comprise operations to
designate the third vehicle as available for rental if the third vehicle is not designated to the reserved status but is determined to have sufficient energy reserves for accommodating a walk-up rental; or
designate the third vehicle as unavailable for rental if the third vehicle is not designated to the reserved status and is determined to have insufficient energy reserves for accommodating a walk-up rental.

32. The computer readable medium of claim 31, wherein the instructions further comprise operations to reenergize the third vehicle while docked at the station.

33. The computer readable medium of claim 32, wherein if the second vehicle is designated as unavailable, then the instructions further comprise operations to lock the third vehicle to the station to prevent removal while reenergizing.

34. The computer readable medium of claim 30, wherein if the third vehicle is detected as docked at the station and the first vehicle is in the available status, then the instructions further comprise operations to
determine whether a second reservation request is pending; and
assign the first to a reserved status to fulfill the second reservation request if the second reservation request is pending; or
maintain the first vehicle in the available status if the second reservation request is not pending.
